(19) United States
(12) Patent Application Publication
(10) Pub. No.: US 2026/0052555 A1
(43) Pub. Date: Feb. 19, 2026

(54) METHOD AND DEVICE FOR ENERGY SAVING IN WIRELESS COMMUNICATION SYSTEM

(71) Applicant: Samsung Electronics Co., Ltd., Gyeonggi-do (KR)

(72) Inventors: Youngbum KIM, Gyeonggi-do (KR); Cheolkyu SHIN, Gyeonggi-do (KR); Junyung YI, Gyeonggi-do (KR)

(21) Appl. No.: 19/101,381

(22) PCT Filed: Aug. 2, 2023
(86) PCT No.: PCT/KR2023/011361

§ 371 Date: Feb. 5, 2025

(30) Foreign Application Priority Data
Aug. 11, 2022 (KR) 10-2022-0100694

(51) Int. Cl. H04W 72/30; H04W 72/0453

(52) U.S. Cl. CPC H04W 72/30; H04W 72/0453

(57) ABSTRACT

The present disclosure relates to a method and device for energy saving in a wireless communication system. The method performed in a base station in order to save energy in a wireless communication system according to an embodiment disclosed herein comprises the steps of: transmitting configuration information about base station bandwidth parts (BWPs) including a first base station BWP and a second base station BWP smaller than the first base station BWP; transmitting, to a terminal, control information instructing a BWP change to the first base station BWP or the second base station BWP; and, when the control information instructs the BWP change to the second base station BWP, receiving or transmitting a signal from or to the terminal within an overlapping area of the second base station BWP and a terminal BWP configured for the terminal.

### TECHNICAL FIELD

The disclosure relates to a communication method in a wireless communication system and, more particularly, to a method and device for energy saving in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks. AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the development of wireless communication systems together with the foregoing, various services may be provided and, thus, a method for effectively providing such services is required. In particular, a method for energy saving in a wireless communication system is required.

### DETAILED DESCRIPTION OF THE INVENTION

### Technical Problem

The disclosure provides an efficient method and device for energy saving in base stations in a wireless communication system.

The disclosure also provides a method and device for configuring/adjusting/changing a bandwidth of at least one of a base station and a UE for energy saving in a wireless communication system.

### Technical Solution

According to an embodiment of the disclosure, a method performed by a base station for energy saving in a wireless communication system comprises transmitting configuration information about base station BWPs including a first base station bandwidth part (BWP) and a second base station BWP having a size smaller than the first base station BWP, transmitting, to a UE, control information indicating a BWP change to the first base station BWP or the second base station BWP, and transmitting or receiving a signal to/from the UE in an overlapping area of the second base station BWP and a UE BWP configured for the UE in case that the control information indicates the BWP change to the second base station BWP.

Further, according to an embodiment of the disclosure, a base station in a wireless communication system comprises a transceiver and a processor configured to transmit, through the transceiver, configuration information about base station BWPs including a first base station bandwidth part (BWP) and a second base station BWP having a size smaller than the first base station BWP, transmit, through the transceiver to a UE, control information indicating a BWP change to the first base station BWP or the second base station BWP, and transmit or receive, through the transceiver, a signal to/from the UE in an overlapping area of the second base station BWP and a UE BWP configured for the UE in case that the control information indicates the BWP change to the second base station BWP.

Further, according to an embodiment of the disclosure, a method performed by a base station for energy saving in a wireless communication system comprises transmitting, to a UE, first configuration information about a first UE bandwidth part (BWP) which is UE-specific, transmitting second configuration information about a second UE BWP commonly applied to a plurality of UEs in a cell of the base station, transmitting, to the UE, control information indicating a BWP to be applied to the UE between the first UE BWP and the second UE BWP, and transmitting or receiving a signal to/from the UE in the second UE BWP in case that the control information indicates the second UE BWP.

Further, according to an embodiment of the disclosure, a base station in a wireless communication system comprises a transceiver and a processor configured to transmit, through the transceiver to a UE, first configuration information about a first UE bandwidth part (BWP) which is UE-specific, transmit, through the transceiver, second configuration information about a second UE BWP commonly applied to a plurality of UEs in a cell of the base station, transmit, through the transceiver to the UE, control information indicating a BWP to be applied to the UE between the first UE BWP and the second UE BWP, and transmit or receive, through the transceiver, a signal to/from the UE in the second UE BWP in case that the control information indicates the second UE BWP.

Further, according to an embodiment of the disclosure, a UE in a wireless communication system comprises a transceiver and a processor configured to receive, through the transceiver, configuration information about base station BWPs including a first base station bandwidth part (BWP) and a second base station BWP having a size smaller than the first base station BWP, receive, through the transceiver from a base station, control information indicating a BWP change to the first base station BWP or the second base station BWP, and communicate with the base station through the transceiver in an overlapping area of the second base station BWP and a UE BWP configured for the UE in case that the control information indicates the BWP change to the second base station BWP.

Further, according to an embodiment of the disclosure, a UE in a wireless communication system comprises a transceiver and a processor configured to receive, through the transceiver from a base station, first configuration information about a first UE bandwidth part (BWP) which is UE-specific, receive, through the transceiver from the base station, second configuration information about a second UE BWP commonly applied to a plurality of UEs in a cell of the base station, receive, through the transceiver from the base station, control information indicating a BWP to be applied to the UE between the first UE BWP and the second UE BWP, and communicate with the base station through the transceiver in the second UE BWP in case that the control information indicates the second UE BWP.

### BRIEF DESCRIPTION OF THE DRAWINGS

FIG. 1 is a view illustrating an example of a basic structure of a time-frequency resource region of a 5G system;

FIG. 2 is a view illustrating an example of a time-domain mapping structure of a synchronization signal and a beam sweeping operation;

FIG. 3 is a view illustrating an example of a random access procedure:

FIG. 4 is a view illustrating an example of a procedure of reporting UE capability information to a base station by a UE;

FIG. 5 is a view illustrating an example of a bandwidth part configuration;

FIG. 6 is a view illustrating a relationship between frequency band, coverage, and bandwidth:

FIG. 7 is a view illustrating an example of a base station deployment scenario;

FIG. 8 is a view illustrating another example of a base station deployment scenario;

FIG. 9 is a view illustrating an example of changing base station BWP configuration according to an embodiment of the disclosure;

FIG. 10 is a view illustrating another example of changing base station BWP configuration according to an embodiment of the disclosure;

FIG. 11 is a view illustrating another example of changing base station BWP configuration according to an embodiment of the disclosure;

FIG. 12 is a view illustrating an example of applying a UE-common BWP and changing a base station transmission bandwidth according to an embodiment of the disclosure;

FIG. 13 is a view illustrating another example of applying a UE-common BWP and changing a base station transmission bandwidth according to an embodiment of the disclosure:

FIG. 14 is a view illustrating another example of applying a UE-common BWP and changing a base station transmission bandwidth according to an embodiment of the disclosure;

FIG. 15 is a view illustrating an example of mapping and transmitting a reference signal by a base station according to an embodiment of the disclosure;

FIG. 16 is a view illustrating an example of a UE procedure according to an embodiment of the disclosure:

FIG. 17 is a view illustrating an example of a base station procedure according to an embodiment of the disclosure;

FIG. 18 is a view illustrating a UE transmission/reception device according to an embodiment of the disclosure:

FIG. 19 is a block diagram illustrating an example of a configuration of a UE according to an embodiment of the disclosure; and

FIG. 20 is a block diagram illustrating an example of a configuration of a base station according to an embodiment of the disclosure.

### MODE FOR CARRYING OUT THE INVENTION

Hereinafter, an embodiment of the disclosure is described with reference to the accompanying drawings. When determined to make the subject matter of the disclosure unclear, the detailed description of the known art or functions may be skipped. The terms as used herein are defined considering the functions in the present disclosure and may be replaced with other terms according to the intention or practice of the user or operator. Therefore, the terms should be defined based on the overall disclosure.

Advantages and features of the present disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the present disclosure. The disclosure is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments, a “ . . . unit” may include one or more processors.

As used herein, each of such phrases as “A or B.” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

When determined to make the subject matter of the disclosure unnecessarily unclear, the detailed description of known functions or configurations may be skipped in describing embodiments of the disclosure. Hereinafter, the disclosure is described in detail with reference to the accompanying drawings.

As used herein, terms for identifying access nodes, terms denoting network entities, terms denoting messages, terms denoting inter-network entity interfaces, and terms denoting various pieces of identification information are provided as an example for ease of description. Thus, the disclosure is not limited to the terms, and the terms may be replaced with other terms denoting objects with equivalent technical meanings.

In the disclosure, the terms “physical channel” and “signal” may be used interchangeably with “data” or “control signal.” For example, physical downlink shared channel (PDSCH) denotes a physical channel where data is transmitted, but PDSCH may also be used to denote data. In other words, the expression “transmits a physical channel” in the disclosure may be equally interpreted as “transmits data or a signal through the physical channel.”

In the disclosure, higher layer signaling refers to a signal transfer method that transfers a signal from the base station to the UE using a physical layer downlink data channel or from the UE to the base station using a physical layer uplink data channel. The higher layer signaling may also be appreciated as radio resource control (RRC) signaling or media access control (MAC) control element (CE).

For ease of description, the disclosure adopts terms and names defined in the 3GPP new radio (NR, 5-generation mobile communication standards). However, the disclosure is not limited by such terms and names and may be likewise applicable to systems conforming to other standards. The term UE may refer to mobile phones, smartphones, IoT devices, sensors, as well as other wireless communication devices.

Hereinafter, the base station may be an entity allocating resource to terminal and may be at least one of gNode B (gNB), eNode B (eNB), Node B, base station (BS), wireless access unit, base station controller, or node over network. The UE may include UE (user equipment), MS (mobile station), cellular phone, smartphone, computer, or multimedia system capable of performing communication functions. Of course, it is not limited to the above examples.

In order to process recently soaring mobile data traffic, the initial standards of the 5th generation (5G) system or the new radio access technology (NR), which is the next-generation communication system after long term evolution (LTE) or evolved universal terrestrial radio access (E-UTRA) and LTE-advanced (LTE-A) or E-UTRA evolution, have been completed. While the conventional mobile communication system focuses on typical voice/data communication, the 5G system aims to meet various services and requirements, such as an enhanced mobile broadband (eMBB) service for enhancing conventional voice/data communication, an ultra-reliable and low latency communication (URLLC) service, and a massive machine type communication (MTC) service supporting a large amount of things communication.

While the legacy LTE and LTE-A system transmission bandwidth per single carrier is limited to up to 20 MHz, the 5G system mainly aims for high-speed data services ranging from several Gbps by utilizing a much wider ultra-wide bandwidth. Accordingly, 5G systems are considering ultra-high frequency bands ranging from several GHz to up to 100 GHz, in which it is relatively easy to secure ultra-wideband width frequencies, as candidate frequencies. Further, it is possible to secure a broadband frequency for a 5G system by relocating or allocating frequencies among frequency bands included in several GHz from hundreds of MHz used in legacy mobile communication systems.

Radio waves in the ultra-high frequency band have a wavelength of several mm and are sometimes called millimeter waves. However, in the ultra-high frequency band, the pathloss of radio waves increases in proportion to the frequency band, and the coverage of the mobile communication system decreases.

In order to overcome the disadvantage of coverage reduction in the ultra-high frequency band, a beamforming technology is applied to increase the arrival distance of radio waves by concentrating the radiation energy of radio waves to a predetermined target point using a plurality of antennas. In other words, in the signal to which the beamforming technology is applied, the beam width of the signal becomes relatively narrow, and radiation energy is concentrated within the narrowed beam width, thereby increasing the radio wave arrival distance. The beamforming technology may be applied to each of the transmission end and the reception end. In addition to the coverage increase effect, the beamforming technology has an effect of reducing interference in areas other than the beamforming direction. In order for the beamforming technology to operate properly, an accurate measurement and feedback method for the transmission/reception beam is required. The beamforming technology may be applied to a control channel or a data channel one-to-one corresponding between a predetermined UE and a base station. Further, beamforming technology for increasing coverage may also be applied to the control channel and data channel for transmitting the common signals transmitted to a plurality of UEs in the system by the base station, e.g., synchronization signal, physical broadcast channel (PBCH), and system information. When the beamforming technology is applied to the common signal, the beam sweeping technology that transmits the signal with the beam direction changed may be additionally applied so that the common signal may reach the UE present at an arbitrary position in the cell.

As another requirement of the 5G system, an ultra-low latency service with a transmission delay of about 1 ms between transmission and reception UEs is required. As one way to reduce transmission delay, it is necessary to design a short transmission time interval (TTI)-based frame structure that is shorter than LTE and LTE-A. The TTI is a basic time unit for performing scheduling, and the TTI of the legacy LTE and LTE-A systems is 1 ms corresponding to the length of one subframe. For example, as a short TTI for meeting the requirements for the ultra-low latency service of the 5G system, 0.5 ms, 0.25 ms, 0.125 ms, etc., which are shorter than legacy LTE and LTE-The systems, are possible.

In the disclosure, the higher layer signaling information may be signaling information corresponding to at least one or a combination of the following signaling information.
Master information block (MIB)
SIB (System Information Block) or SIB X (X=1, 2, . . . )
Radio resource control (RRC) information
Medium access control (MAC) control element (CE)

Further, L1 signaling information may be signaling information corresponding to at least one or a combination of one or more of the following physical layer channels or signaling methods using signaling.
Physical downlink control channel (PDCCH)
Downlink control information (DCI)
UE-specific DCI
Group common DCI
Common DCI

Further, in the following embodiments of the disclosure, the information transmitted and received by the higher layer signaling information between the base station and the UE may also be transmitted and received by various combinations of the higher layer signaling information and/or the L1 signaling information.

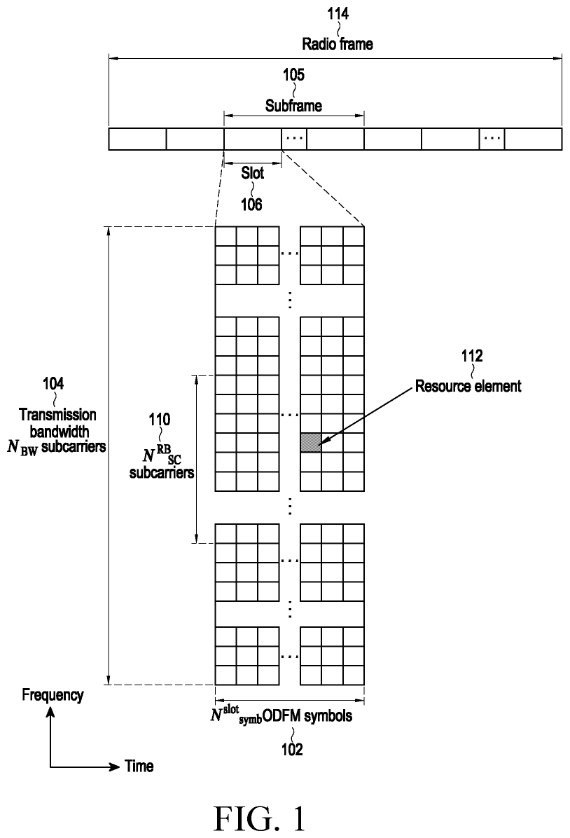

FIG. 1 is a view illustrating an example of a basic structure of a time-frequency resource region of a 5G system. In other words, FIG. 1 is a view illustrating a basic structure of a time-frequency resource region, which is a radio resource region in which data or control channels are transmitted in a 5G system.

Referring to FIG. 1, the horizontal axis refers to the time domain, and the vertical axis refers to the frequency domain. The minimum transmission unit in the time domain of the 5G system is an orthogonal frequency division multiplexing (OFDM) symbol,

$${N}_{symb}^{slot}$$

symbols 102 may be gathered to form one slot 106, and

$${N}_{slot}^{subframe}$$

slots may be gathered to form one subframe 105. The length of the subframe is 1.0 ms, and 10 subframes may be gathered to form a 10 ms frame 114. In the frequency domain, the minimum transmission unit is subcarrier, and the bandwidth of the overall system transmission band may consist of a total of New (104) subcarriers.

The basic resource unit in the time-frequency domain is resource element (RE) 112, and this may be represented with an OFDM symbol index and a subcarrier index. A resource block (RB) (or physical resource block (PRB) may be defined as

$${N}_{\text{?}}^{\text{?}}$$

$$\text{?} \text{indicates text missing or illegible when filed}$$

contiguous subcarriers 110 in the frequency domain. In the 5G system,

$$\text{?} = 12 ,$$

$$\text{?} \text{indicates text missing or illegible when filed}$$

and the data rate may increase in proportion to the number of RBs scheduled for the UE.

In a 5G system, a base station may map data on an RB basis and generally perform scheduling on the RBs that constitute one slot for a given UE. In other words, the basic time unit in which scheduling is performed in the 5G system may be a slot, and the basic frequency unit in which scheduling is performed may be an RB.

The number

$$\text{?}$$

$$\text{?} \text{indicates text missing or illegible when filed}$$

of OFDM symbols is determined according to the length of the cyclic prefix (CP) added to each symbol to prevent interference between symbols. For example, when a normal CP is applied,

$$\text{?} = 14 ,$$

$$\text{?} \text{indicates text missing or illegible when filed}$$

and when an extended CP is applied when a normal CP is applied

$$\text{?} = 12.$$

$$\text{?} \text{indicates text missing or illegible when filed}$$

The extended CP is applied to systems where the radio transmission distance is relatively longer than the normal CP, maintaining the orthogonality between symbols. In the case of the normal CP, the ratio between CP length and symbol length is maintained as a constant value, so that the overhead due to the CP may remain constant regardless of subcarrier spacing. In other words, when the subcarrier spacing decreases, the symbol length may increase, and the CP length may also increase accordingly. Conversely, when the subcarrier spacing increases, the symbol length may decrease, and thus the CP length may decrease. The symbol length and the CP length may be inversely proportional to the subcarrier spacing.

In a 5G system, various frame structures may be supported by adjusting subcarrier spacing to meet various services and requirements. For example,
From the perspective of the operating frequency band, the larger the subcarrier spacing, the more advantageous it is to recovery of phase noise in a high frequency band.
From a transmission time perspective, if the subcarrier spacing is large, the symbol length in the time domain is shortened, and as a result, the slot length is shortened, which is advantageous in supporting ultra-low delay services, such as URLLC.
From a cell size perspective, the longer the CP length, the larger cells may be supported, so that the smaller the subcarrier spacing, the relatively larger cells may be supported. In mobile communications, cell is a concept that refers to an area covered by one base station.

Subcarrier spacing, CP length, etc. are essential information for OFDM transmission/reception, and seamless transmission/reception is possible only when the base station and UE recognize subcarrier spacing, CP length, etc. as common values. Table 1 illustrates the relationship between subcarrier spacing configuration #, subcarrier spacing (Δf), and CP length supported by the 5G system.

TABLE 1

| μ | Δf = 2^{μ} · 15[kHz] | Cyclic prefix |
|---|---|---|
| 0 | 15 | Normal |
| 1 | 30 | Normal |
| 2 | 60 | Normal, |
| | | Extended |
| 3 | 120 | Normal |
| 4 | 240 | Normal |

Table 2 illustrates the number

$$( \text{?} )$$

$$\text{?} \text{indicates text missing or illegible when filed}$$

of symbols per slot, the number

$$( \text{?} )$$

$$\text{?} \text{indicates text missing or illegible when filed}$$

of slots per frame, and the number

$$( \text{?} )$$

$$\text{?} \text{indicates text missing or illegible when filed}$$

of slots per subframe, for each subcarrier spacing configuration (μ) in the case of the normal CP.

TABLE 2

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 illustrates the number

$$( \text{?} )$$

$$\text{?} \text{indicates text missing or illegible when filed}$$

of symbols per slot, the number

$$( \text{?} )$$

$$\text{?} \text{indicates text missing or illegible when filed}$$

of slots per frame, and the number

$$( \text{?} )$$

$$\text{?} \text{indicates text missing or illegible when filed}$$

of slots per subframe, for each subcarrier spacing configuration (μ) in the case of the extended CP.

TABLE 3

| v | ${N}_{symb}^{slot}$ | ${N}_{slot}^{frame , μ}$ | ${N}_{slot}^{subframe , μ}$ |
|---|---|---|---|
| 2 | 12 | 40 | 4 |

At the early stage of introduction of the 5G system, coexistence or dual-mode operation with, at least, the legacy LTE and/or LTE-A (hereinafter, LTE/LTE-A) is expected. As a result, the legacy LTE/LTE-A may provide stable system operation to the UE, and the 5G system may provide enhanced services to the UE. Therefore, the frame structure of the 5G system needs to include at least the LTE/LTE-A frame structure or essential parameter set (subcarrier spacing=15 kHz).

For example, when comparing a frame structure with a subcarrier spacing configuration μ=0 (hereinafter frame structure A) and a frame structure with a subcarrier spacing configuration μ=1 (hereinafter frame structure B), as compared to frame structure A, frame structure B has the subcarrier spacing and RB size increased in double, and the slot length and symbol length decreased in double. In the case of frame structure B, 2 slots may make up 1 subframe, and 20 subframes may make up 1 frame.

When the frame structure of the 5G system is generalized, the subcarrier spacing, the CP length, the slot length, etc., which are essential parameter sets, are allowed to have an integer multiple relationship therebetween for each frame structure, thereby providing high scalability. A subframe having a fixed length of 1 ms may be defined to represent a reference time unit irrelevant to the frame structure.

The frame structure may be applied in response to various scenarios. From a cell size point of view, the longer the CP length, the larger cell may be supported, so that frame structure A may support a cell relatively larger than frame structure B. From an operating frequency band perspective, the larger the subcarrier spacing, the more advantageous it is to recover the phase noise in a high frequency band, so that frame structure B may support a relatively higher operating frequency than frame structure A. From a service point of view, a shorter length of the slot which is the basic time unit of scheduling may be more advantageous to support an ultra low latency service, such as URLLC, so that frame structure B may be appropriate for the URLLC service as compared with frame structure A.

Hereinafter, in the description of the disclosure, the uplink (UL) may refer to a wireless link in which the UE transmits data or the control signal to the base station, and the downlink (DL) may refer to a wireless link in which the base station transmits data or the control signal to the UE.

In the initial access step in which the UE accesses the system for the first time, the UE may synchronize downlink time and frequency from a synchronization signal transmitted by the base station through a cell search and obtain a cell ID. The UE may receive a physical broadcast channel (PBCH) using the obtained cell ID and obtain a master information block (MIB) that is essential system information from the PBCH. Additionally, the UE may receive system information (SIB) transmitted by the base station to obtain cell-common transmission/reception-related control information. The cell-common transmission/reception-related control information may include random access-related control information, paging-related control information, and common control information about various physical channels.

A synchronization signal is a signal that is a reference signal for cell search, and subcarrier spacing may be applied for each frequency band to suit the channel environment, such as phase noise. In the case of a data channel or a control channel, different subcarrier spacings may be applied depending on service types to support various services as described above.

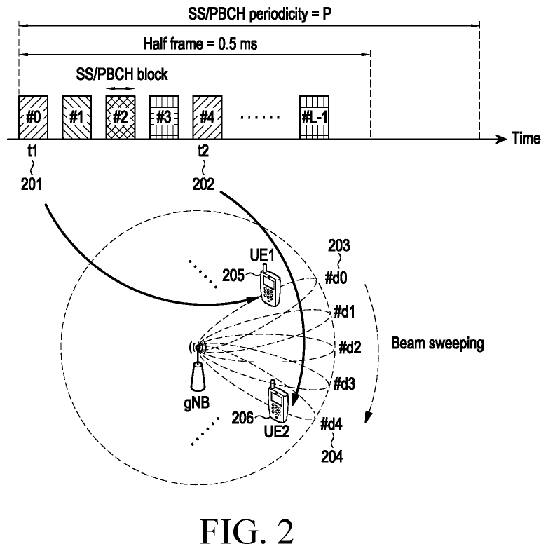

FIG. 2 is a view illustrating an example of a time-domain mapping structure of a synchronization signal and a beam sweeping operation.

For purposes of illustration, the following components may be defined:
Primary synchronization signal (PSS): A signal that serves as a reference for DL time/frequency synchronization and provides part of the information for cell ID
Secondary synchronization signal (SSS): serves as a reference for DL time/frequency synchronization and provides remaining partial cell ID information. Additionally, it may serve as a reference signal for demodulation of PBCH.
Physical broadcast channel (PBCH): provides a master information block (MIB), which is essential system information required data channel and control channel transmission/reception by the UE. The essential system information may include search space-related control information indicating radio resource mapping information about a control channel, scheduling control information for a separate data channel for transmitting system information, and information, such as system frame number (SFN), which is the frame unit index serving as a timing reference.
Synchronization signal/PBCH block or SSB (SS/PBCH block): The SS/PBCH block is constituted of N OFDM symbols and is composed of a combination of the PSS, SSS, and PBCH. In the case of a system to which beam sweeping technology is applied, the SS/PBCH block is the minimum unit to which beam sweeping is applied. In the 5G system, N=4. The base station may transmit up to L SS/PBCH blocks. The L SS/PBCH blocks are mapped within a half frame (0.5 ms). The L SS/PBCH blocks are periodically repeated every predetermined period P. The base station may inform the UE of the period P. If there is no separate signaling for the period P, the UE applies a previously agreed default value. Each SS/PBCH block has an SS/PBCH block index from 0 up to L−1, and the UE may know the SS/PBCH block index through SS/PBCH detection. The SS/PBCH block may be referred to as a synchronization signal block (SSB) or a synchronization signal.

FIG. 2 illustrates an example in which beam sweeping applies every SS/PBCH block. In the example of FIG. 2, #d0 to #d4 exemplify beam directions of radiations according to beam sweeping of the base station. UE1 205 receives the SS/PBCH block using the beam radiated in direction #d0 203 by the beamforming applied to SS/PBCH block #0 at time t1 201. UE2 206 receives the SS/PBCH block using the beam radiated in direction #d4 204 by the beamforming applied to SS/PBCH block #4, at time t2 202. The UE may obtain an optimal synchronization signal through the beam radiated from the base station in the direction where the UE is positioned. In the example of FIG. 2, it may be difficult for UE1 205 to obtain time/frequency synchronization and essential system information from the SS/PBCH block through the beam radiated in direction #d4 away from the position of UE1 205.

In addition to the initial access procedure, the UE may also receive the SS/PBCH block to determine whether the radio link quality of the current cell is maintained at a certain level or higher. Further, in a handover procedure in which the UE moves access from the current cell to the neighboring cell, the UE may determine the radio link quality of the neighboring cell and receive the SS/PBCH block of the neighboring cell to obtain time/frequency synchronization of the neighboring cell.

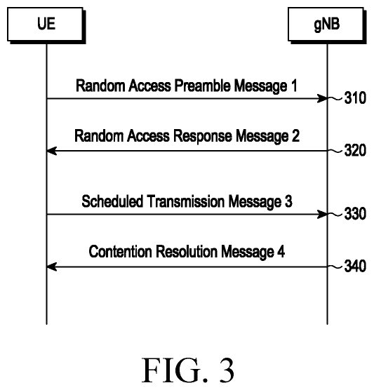

After the UE obtains MIB and system information from the base station through the initial access procedure, the UE may perform a random access procedure to switch the link with the base station to the connected state (or RRC_CONNECTED state). If completing the random access procedure, the UE switches to the connected state, and one-to-one communication becomes possible between the base station and the UE. A random access procedure is described below in detail with reference to FIG. 3.

FIG. 3 is a view illustrating an example of a random access procedure.

Referring to FIG. 3, as a first step 310 of the random access procedure, the UE transmits a random access preamble to the base station. In the random access procedure, the random access preamble, which is the first transmission message of the UE, may be referred to as message 1. The base station may measure a transmission delay value between the UE and the base station from the random access preamble and may synchronize uplink. In this case, the UE may arbitrarily select which random access preamble to use within the random access preamble set given by the system information in advance. The initial transmission power of the random access preamble may be determined according to a pathloss between the base station and the UE measured by the UE. Further, the UE may determine the transmission beam direction of the random access preamble from the synchronization signal received from the base station and transmit the random access preamble.

In a second step 320, the base station transmits an uplink transmission timing adjustment command to the UE based on the transmission delay value measured from the random access preamble received from the first UE 310. Further, the base station may transmit an uplink resource and power control command to be used by the UE as scheduling information. The scheduling information may include control information for the uplink transmission beam of the UE.

When the UE does not receive a random access response (RAR) (or message 2) which is scheduling information for message 3 from the base station within a predetermined time in the second step 320, the first step 310 may be performed again. When the first step 310 is performed again, the UE may stepwise increase the transmission power of the random access preamble and transmit the same (power ramping), thereby increasing the random access preamble reception probability of the base station.

In a third step 330, the UE transmits, to the base station, uplink data (message 3) including its UE ID through an uplink data channel (physical uplink shared channel (PUSCH)) using the uplink resource allocated in the second step 320. The transmission timing of the uplink data channel for transmitting message 3 may follow the timing control command received from the base station in the second step 320. The transmission power of the uplink data channel for transmitting message 3 may be determined considering the power control command received from the base station and the power ramping value of the random access preamble in the second step 320. The uplink data channel for transmitting message 3 may refer to the first uplink data signal that the UE transmits to the base station after transmitting the random access preamble.

In a fourth step 340, if the base station determines that the UE has performed random access without collision with other UEs in the fourth step 340, the base station transmits, to the UE, data including the ID of the UE that has transmitted the uplink data in the third step 330. If the signal transmitted by the base station is received from the base station in the fourth step, the UE may determine that the random access is successful. The UE transmits HARQ-ACK information indicating whether the message 4 has been successfully received to the base station through the physical uplink control channel (PUCCH).

If the base station fails to receive a data signal from the UE because the data transmitted by the UE in the third step 330 and data from another UE collide with each other, the base station may not perform any further data transmission to the UE. Accordingly, if the UE fails to receive the data transmitted from the base station in the fourth step 340 within a predetermined period of time, it is determined that the random access procedure has failed and the UE may start again from the first step 310.

If successfully completing the random access procedure, the UE switches to the connected state, and one-to-one communication becomes possible between the base station and the UE. The base station may receive UE capability information from the UE in the connected state and adjust scheduling by referring to the UE capability information about the corresponding UE. The UE may inform the base station of whether the UE itself supports a predetermined function, the maximum allowable value of the function supported by the UE, and the like through the UE capability information. Accordingly. UE capability information that each UE reports to the base station may be a different value for each UE.

For example, the UE may report UE capability information including at least one of the following control information to the base station as the UE capability information.
frequency band related control Information supported by UE
control information related to channel bandwidth supported by UE
control information related to maximum modulation method supported by UE
control information related to maximum beam number supported by terminal
control information related to maximum layer number supported by UE
control information related to channel state information (CSI) reporting supported by UE
control information about whether UE supports frequency hopping
bandwidth-related control information when carrier aggregation (CA) is supported
control information about whether cross carrier scheduling is supported when carrier aggregation is supported

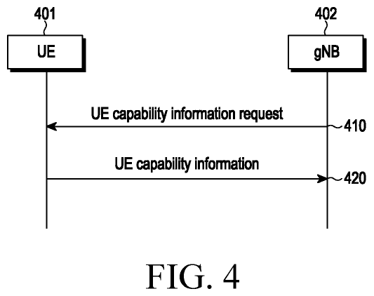

FIG. 4 is a view illustrating an example of a procedure of reporting UE capability information to a base station by a UE.

Referring to FIG. 4, in step 410, the base station 402 may transmit a UE capability information request message to the UE 401. According to the UE capability information request of the base station, the UE transmits the above-described UE capability information to the base station in step 420.

Hereinafter, a scheduling method in which the base station transmits downlink data to a UE or instructs the UE to transmit uplink data is described.

Downlink control information (DCI) is control information transmitted by the base station to the UE through downlink and may include downlink data scheduling information or uplink data scheduling information for a predetermined UE. In general, the base station may independently perform channel coding for DCI for each UE and then transmit the DCI to each UE through a physical downlink control channel (PDCCH), which is a downlink physical control channel.

The base station may apply, to the UE to be scheduled, a predetermined DCI format determined according to the purpose such as whether it is scheduling information (downlink assignment) for downlink data, whether it is scheduling information (uplink grant) for uplink data, or whether it is DCI for power control.

The base station may transmit downlink data to the UE through a physical downlink shared channel (PDSCH), which is a physical channel for downlink data transmission. The base station may inform the UE of scheduling information such as a specific mapping position in the time and frequency domain of the PDSCH, a modulation scheme. HARQ-related control information, and power control information through the DCI related to downlink data scheduling information among DCIs transmitted through the PDCCH.

The UE may transmit uplink data to the base station through a physical uplink shared channel (PUSCH), which is a physical channel for uplink data transmission. The base station may inform the UE of scheduling information such as a specific mapping position in the time and frequency domain of the PUSCH, modulation scheme, HARQ-related control information, power control information, etc. through the DCI related to uplink data scheduling information among DCIs transmitted through the PDCCH.

The time-frequency resource to which the PDCCH is mapped is referred to as a control resource set (CORESET). The CORESET may be configured in all or some frequency resources of a bandwidth supported by the UE in the frequency domain. In the time domain, one or more OFDM symbols may be set, which may be defined as a control resource set duration (CORESET) length. The base station may configure one or more CORESETs for the UE through higher layer signaling (e.g., system information, master information block (MIB), radio resource control (RRC) signaling, etc.). “The base station configures the CORESET to the UE” may mean that the base station provides the UE with information such as a CORESET identifier, a frequency position of the CORESET, and a symbol length of the CORESET. The information provided by the base station to the UE to configure the CORESET may include at least one of the information included in Table 4.

TABLE 4

| | |
|---|---|
| ControlResourceSet ::= | SEQUENCE { |
| controlResourceSetId | ControlResourceSetId, |

(CORESET identifier)

| | |
|---|---|
| frequencyDomainResources | BIT STRING (SIZE (45)), |

(frequency domain resource)

| | |
|---|---|
| duration | INTEGER (1..maxCoReSetDuration), |

(CORESET length)

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, n6}, |

(REG bundle size)

| | |
|---|---|
| interleaverSize | ENUMERATED {n2, n3, n6}, |

(interleaver size)

| | |
|---|---|
| shiftIndex | INTEGER(0..maxNrofPhysicalResourceBlocks-1) |

```
OPTIONAL -- Need S
        (interleaver shift)
      },
```

| | |
|---|---|
| noninterleaved | NULL |

},

| | |
|---|---|
| precoderGranularity | ENUMERATED {sameAsREG-bundle, |

allContiguousRBs},
(precoding unit)

| | |
|---|---|
| tci-StatesPDCCH-ToAddList | SEQUENCE(SIZE (1..maxNrofTCI- |

StatesPDCCH)) OF TCI-StateId OPTIONAL, -- Cond NotSIB1-initialBWP
(QCL configuration information)

| | |
|---|---|
| tci-StatesPDCCH-ToReleaseList | SEQUENCE(SIZE (1..maxNrofTCI- |

StatesPDCCH)) OF TCI-StateId OPTIONAL, -- Cond NotSIB1-initialBWP
(QCL configuration information)

| | |
|---|---|
| tci-PresentInDCI | ENUMERATED {enabled} |

OPTIONAL, -- Need S
(QCL indicator configuration information in DCI)

| | |
|---|---|
| pdcch-DMRS-ScramblingID | INTEGER (0..65535) |

OPTIONAL, -- Need S
(PDCCH DMRS scrambling identifier)
}

The CORESET may be constituted of

$$\text{?}$$

$$\text{?} \text{indicates text missing or illegible when filed}$$

RBs in the frequency domain, and be constituted of

$$\text{?} ∈ \{ 1 , 2 , 3 \}$$

$$\text{?} \text{indicates text missing or illegible when filed}$$

in the time domain. The NR PDCCH may be constituted of one or more control channel elements (CCEs). One CCE may consist of 6 resource element groups (REGs), and the REG may be defined as 1 RB during 1 OFDM symbol. In one CORESET, REGs may be indexed in a time-first order, starting with REG index 0 from the first OFDM symbol of the CORESET, the lowest RB.

An interleaved scheme and a non-interleaved scheme may be supported as transmission schemes for the PDCCH. The base station may configure the UE with whether to perform interleaving transmission or non-interleaving transmission for each CORESET, through higher layer signaling. Interleaving may be performed in each REG bundle unit. A REG bundle may be defined as a set of one or multiple REGs. The UE may determine a CCE-to-REG mapping scheme in the corresponding CORESET, in a manner shown in Table 5 below, based on whether to perform interleaving or non-interleaving transmission, configured by the base station.

```
TABLE 5
The CCE-to-REG mapping for a control-resource set can be interleaved
or non-interleaved and is described by REG bundles:
  REG bundle i is defined as REGs {iL, iL, + 1, . . . , iL + L − 1} where
  L is the REG bundle size, t = 0, 1, . . . ,
  ${N}_{REG}^{CORESET} / L - 1 , and {N}_{REG}^{CORESET} = {N}_{RB}^{CORESET} {N}_{symb}^{CORESET}$
  is the number of REGs in the CORESET CCE j consists of REG
  bundles └ [symbol]   (6j/L), [symbol]  (6jfL + 1), . . . , f(6 [symbol]   L + 6/L − 1)┘
  where f(−) is an interleaver
For non-interleaved CCE-to-REG mapping, L = 6 and f(x) = x,
For interleaved CCE-to-REG mapping,
$L ∈ \{ 2 , 6 \} for {N}_{symb}^{CORESET} = 1 and$
$L ∈ \{ {N}_{symb}^{CORESET} , 6 \} for {N}_{symb}^{CORESET} ∈ \{ 2 , 3 \} .$
The interleaver is defined by
  $f ( x ) = ( rC + c + {n}_{shift} ) mod ( {N}_{REG}^{CORESET} / L )$
            x = cR + r
          r = 0, 1, . . . , R − 1
          c = 0, 1, . . . , C − 1
        $C = {N}_{REG}^{CORESET} / ( LR )$
where R ∈ [2 [symbol]  3.6}, [symbol]
indicates data missing or illegible when filed
```

The base station may provide configuration information, such as information regarding the symbols where the PDCCH is mapped in the slot and transmission period, to the UE through the above-described higher layer signaling.

The search space of the PDCCH is described below. The number of CCEs necessary to transmit a PDCCH may be, e.g., 1, 2, 4, 8, or 16 depending on the aggregation level (AL), and different numbers of CCEs may be used for link adaptation of downlink control channel. For example, if AL=L, one downlink control channel may be transmitted via L CCEs. The UE performs blind decoding to detect a signal while being unaware of information for downlink control channel and, to that end, a search space may be defined which indicates a set of CCEs. The search space is a set of candidate control channels constituted of CCEs that the UE needs to attempt to decode on the given aggregation level, and since there are several aggregation levels to bundle up 1, 2, 4, 8, or 16 CCEs, the UE has a plurality of search spaces. A search space set may be defined as a set of search spaces at all set aggregation levels.

The search spaces may be classified into a common search space (CSS) and a UE-specific search space (USS). A predetermined group of UEs or all the UEs may investigate the common search space of the PDCCH to receive cell-common control information, e.g., paging message, or dynamic scheduling for system information (system information block (SIB)). For example, the UE may receive scheduling allocation information about PDSCH for system information reception by examining the common search space of PDCCH. In the case of the common search space, since a certain group of UEs or all the UEs need receive the PDCCH, it may be defined as a set of CCEs previously agreed on. The UE may receive scheduling allocation information for the UE-specific PDSCH or PUSCH by inspecting the UE-specific search space of PDCCH. The UE-specific search space may be UE-specifically defined with a function of various system parameters and the identity (ID) of the UE.

The base station may configure, to the UE, configuration information for the search space of the PDCCH using higher layer signaling (e.g., SIB, MIB, or RRC signaling). For example, the base station may configure the UE with, e.g., the number of PDCCH candidates at each aggregation level L, monitoring period for search space, monitoring occasion of symbol unit in slot for search space, search space type (common search space or UE-specific search space), combination of RNTI and DCI format to be monitored in the search space, and CORESET index to be monitored in the search space. For example, parameters for the search space for the PDCCH may include at least one of information as shown in Table 6 below.

TABLE 6

| | |
|---|---|
| SearchSpace ::= | SEQUENCE { |
| searchSpaceId | SearchSpaceId, |

(search space identifier)

| | |
|---|---|
| controlResourceSetId | ControlResourceSetId |

```
OPTIONAL, -- Cond SetupOnly
  (CORESET identifier)
    monitoringSlotPeriodicityAndOffset CHOICE {
  (monitoring slot level periodicity and offset)
```

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559) |
| } | |

OPTIONAL, -- Cond Setup

| | |
|---|---|
| duration | INTEGER (2..2559) |

OPTIONAL, -- Need R
(monitoring length)

| | |
|---|---|
| monitoringSymbolsWithinSlot | BIT STRING (SIZE (14)) |

OPTIONAL, -- Cond Setup
(monitoring symbol position in slot)

| | |
|---|---|
| nrofCandidates | SEQUENCE { |

(number of PDCCH candidate groups per aggregation level)

| | |
|---|---|
| aggregationLevel1 | ENUMERATED {n0, n1, n2, n3, n4, |

n5, n6, n8},

| | |
|---|---|
| aggregationLevel2 | ENUMERATED {n0, n1, n2, n3, n4, |

n5, n6, n8},

| | |
|---|---|
| aggregationLevel4 | ENUMERATED {n0, n1, n2, n3, n4, |

n5, n6, n8},

| | |
|---|---|
| aggregationLevel8 | ENUMERATED {n0, n1, n2, n3, n4, |

n5, n6, n8},

| | |
|---|---|
| aggregationLevel16 | ENUMERATED {n0, n1, n2, n3, n4, |

n5, n6, n8}
}
OPTIONAL, -- Cond Setup

| | |
|---|---|
| searchSpaceType | CHOICE { |

(search space type)

| | |
|---|---|
| common | SEQUENCE { |

(common search space)

| | |
|---|---|
| dci-Format0-0-AndFormat1-0 | SEQUENCE { |

```
              ...
          }
OPTIONAL, -- Need R
```

| | |
|---|---|
| dci-Format2-0 | SEQUENCE { |
| nrofCandidates-SFI | SEQUENCE { |
| aggregationLevel1 | ENUMERATED {n1, |

n2} OPTIONAL, -- Need R

| | |
|---|---|
| aggregationLevel2 | ENUMERATED {n1, |

n2} OPTIONAL, -- Need R

| | |
|---|---|
| aggregationLevel4 | ENUMERATED {n1, |

n2} OPTIONAL, -- Need R

| | |
|---|---|
| aggregationLevel8 | ENUMERATED {n1, |

n2} OPTIONAL, -- Need R

| | |
|---|---|
| aggregationLevel16 | ENUMERATED {n1, |

```
n2} OPTIONAL -- Need R
              },
              ...
          }
OPTIONAL, -- Need R
```

| | |
|---|---|
| dci-Format2-1 | SEQUENCE { |

```
              ...
          }
OPTIONAL, -- Need R
```

| | |
|---|---|
| dci-Format2-2 | SEQUENCE { |

```
              ...
          }
OPTIONAL, -- Need R
```

| | |
|---|---|
| dci-Format2-3 | SEQUENCE { |
| dummy1 | ENUMERATED {sl1, sl2, |

sl4, sl5, sl8, sl10, sl16, sl20} OPTIONAL, -- Cond Setup

| | |
|---|---|
| dummy2 | ENUMERATED {n1, n2}, |

```
            ...
        }
OPTIONAL -- Need R
      },
```

| | |
|---|---|
| ue-Specific | SEQUENCE { |

(UE-specific search space)

| | |
|---|---|
| dci-Formats | ENUMERATED {formats0- |

```
0-And-1-0, formats0-1-And-1-1},
        ...,
      }
  }
OPTIONAL -- Cond Setup2
}
```

According to the configuration information, the base station may configure one or more search space sets to the terminal. According to some embodiments, the base station may configure search space set 1 and search space set 2 to the UE. Search space set 1 may be configured so that the UE monitors DCI format A, scrambled with, e.g., X-RNTI (radio network temporary identifier), in the common search space, and search space set 2 may be configured so that the UE monitors DCI format B, scrambled with Y-RNTI, in the UE-specific search space.

According to the configuration information, one or more search space sets may be present in the common search space or the UE-specific search space. For example, search space set #1 and search space set #2 may be configured as the common search space, and search space set #3 and search space set #4 may be configured as the UE-specific search space.

In the common search space, the UE may monitor combinations of DCI formats and RNTIs as follows. Of course, it is not limited to the examples described below.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the UE-specific search space, the UE may monitor combinations of DCI formats and RNTIs as follows. Of course, it is not limited to the examples described below.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

For example, the RNTIs may be defined and used as follows.
Cell RNTI (C-RNTI): for scheduling UE-specific PDSCH or PUSCH
Temporary cell RNTI (TC-RNTI): for scheduling UE-specific PDSCH
Configured scheduling RNTI (CS-RNTI): for scheduling semi-statically configured UE-specific PDSCH
Random access RNTI (RA-RNTI): for scheduling PDSCH in the random access phase
Paging RNTI (P-RNTI): for scheduling PDSCH where paging is transmitted
System information RNTI (SI-RNTI): for scheduling PDSCH where system information is transmitted
Interruption RNTI (INT-RNTI): for indicating whether to puncture PDSCH
Transmit power control for PUSCH RNTI (TPC-PUSCH-RNTI): for indicating power control command for PUSCH
Transmit power control for PUCCH RNTI (TPC-PUCCH-RNTI): for indicating power control command for PUCCH
Transmit power control for SRS RNTI (TPC-SRS-RNTI): for indicating power control command for SRS

The above-described DCI formats may follow the definitions in Table 7 below:

TABLE 7

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) where |
| | UE may assume no transmission is intended for the UE |
| 2_2 | Transmission of TPC commands for PUCCH and PUSCH |
| 2_3 | Transmission of a group of TPC commands for SRS transmissions |
| | by one or more UEs |

The search space of the aggregation level L in CORESET p and the search space set's may be expressed by the following equation.

$$L \cdot \{ ( \text{?} + ⌊ \frac{\text{?} \cdot {N}_{CCE , p}}{L \cdot \text{?}} ⌋ + {n}_{CI} ) mod ⌊ {N}_{CCE , p} / L ⌋ \} + i \qquad [ Equation 1 ]$$

$$\text{?} \text{indicates text missing or illegible when filed}$$

L: aggregation level
n_{CI}: carrier index
N_{CCE,p}: total number of CCEs present in control resource set p
n^{u}_{s,f}: slot index
M^{(L)}_{p,a,max}: number of PDCCH candidate groups of aggregation level L
m_{snCI}=0, . . . , M^{(L)}_{p,s,max}−1: PDCCH candidate group index of aggregation level L
i=0 . . . , L−1
Y_{p,p}_{ₛ₂}_{ⁿ}=(Aₚ·Y_{p,c}_{₁}_{^{v}}₋₁) Yₚ_{_{c}}₋₁=n_{RNTI}≠0, Aᵢⱼ=39827, A₂=39839, D=65537
n_{RNTI}: UE identifier

$$\text{?}$$

$$\text{?} \text{indicates text missing or illegible when filed}$$

may be 0 in the case of the common search space.

In the case of the UE-specific search space,

$$\text{?}$$

$$\text{?} \text{indicates text missing or illegible when filed}$$

may be a value that changes depending on the UE's ID (C-RNTI or ID configured in the UE by the base station) and the time index.

A configuration of a bandwidth part (BWP) in a 5G communication system is described below in detail with reference to the drawings.

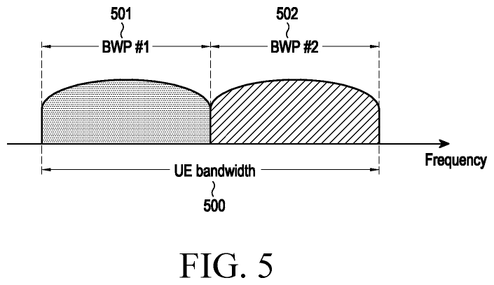

FIG. 5 is a view illustrating an example of a configuration for a UE bandwidth part in a 5G communication system.

FIG. 5 illustrates an example in which a UE bandwidth 500 is divided into two bandwidth parts, e.g., bandwidth part #1 (BWP #1) 501 and bandwidth part #2 (BWP #2) 502. The base station may configure one or more bandwidth parts in the UE and may configure the following information for each bandwidth part.

TABLE 8

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part position and bandwidth of frequency domain)

| | |
|---|---|
| subcarrierSpacing | ENUMERATED {n0, n1, n2, n3, n4, n5}, |

(subcarrierSpacing: n0=15kHz, n1=30kHz, n2=60kHz, n3=120kHz, n4=240kHz,
...)

| | |
|---|---|
| cyclicPrefix | ENUMERATED { extended } |

(cyclic prefix: normal CP or extended CP)
}

However, without being limited thereto, other various BWP-related parameters than the above-described configuration information may be configured in the UE. The base station may transfer the information to the UE through higher layer signaling, e.g., radio resource control (RRC) signaling. At least one bandwidth part (BWP) among one or more configured bandwidth parts may be activated. Whether to activate the configured bandwidth part may be configured from the base station to the UE semi-statically through RRC signaling or dynamically changed through downlink control information (DCI).

According to an embodiment, before radio resource control (RRC) connected, the UE may be configured with an initial bandwidth part (BWP) for initial access by the base station via a master information block (MIB). More specifically, the UE may receive configuration information for a search space and control resource set (CORESET) in which physical downlink control channel (PDCCH) may be transmitted to receive system information (remaining system information, RMSI or system information block 1 which may correspond to SIB1) necessary for initial access through the MIB in the initial access phase. Each of the control region and search space configured with the MIB may be regarded as identity (ID) 0. The base station may provide the UE with configuration information, such as frequency allocation information, time allocation information, and subcarrier spacing for control region #0, via the MIB. Further, the base station may provide the UE with configuration information for occasion and monitoring period for control region #0, i.e., configuration information for search space #0, via the MIB. The UE may regard the frequency range set as control region #0 obtained from the MIB, as the initial BWP for initial access. In this case, the identity (ID) of the initial BWP may be regarded as 0.

The configuration of the bandwidth part supported in 5G described above may be used for various purposes.

According to an embodiment, when the bandwidth supported by the UE is smaller than the system bandwidth, this may be supported through the bandwidth part configuration. For example, as the base station configures the UE with the frequency position (configuration information 2) of the bandwidth part, the UE may transmit/receive data in a specific frequency position in the system bandwidth.

According to an embodiment, for the purpose of supporting different subcarrier spacings, the base station may configure the UE with a plurality of bandwidth parts. For example, to support data transmission/reception using a subcarrier spacing of 15 kHz and a subcarrier spacing of 30 kHz for some UE, the base station may configure the UE with two bandwidths, as subcarrier spacings of 15 kHz and 30 kHz. The different bandwidth parts may be frequency division multiplexed and, when data is transmitted/received at a specific subcarrier spacing, the bandwidth part configured as the corresponding subcarrier spacing may be activated.

According to an embodiment, for the purpose of reducing power consumption of the UE, the base station may configure the UE with bandwidth parts having different sizes of bandwidths. For example, when the UE supports a bandwidth exceeding a very large bandwidth, e.g., a bandwidth of 100 MHz, and transmits/receives data always using the bandwidth, significant power consumption may occur. In particular, it is very inefficient in terms of power consumption to monitor an unnecessary downlink control channel using a large bandwidth of 100 MHz in a situation where there is no traffic. For the purpose of reducing power consumption of the UE, the base station may configure a bandwidth part of a relatively small bandwidth to the UE, e.g., a bandwidth part of 20 Mhz, in the UE. In a no-traffic situation, the UE may perform monitoring in the 20 MHz bandwidth and, if data occurs, the UE may transmit/receive data in the 100 MHz bandwidth according to an instruction from the base station.

In a method for configuring a bandwidth part, UEs before RRC connected may receive configuration information for an initial bandwidth via a master information block (MIB) in the initial access phase. More specifically, the UE may be configured with a control region (CORESET) for the downlink control channel where the downlink control information (DCI) scheduling the system information block (SIB) may be transmitted from the MIB of the physical broadcast channel (PBCH). The bandwidth of the control region configured through the MIB may be regarded as the initial bandwidth part, and the UE may receive the physical downlink shared channel (PDSCH), which transmits the SIB, via the configured initial bandwidth part. The initial bandwidth part may be utilized for other system information (OSI), paging, and random access as well as for receiving SIB.

If the UE is configured with one or more bandwidth parts, the base station may indicate, to the UE, a change in bandwidth part using the bandwidth part indicator in the DCI. As an example, when the currently activated bandwidth part of the UE is bandwidth part #1 501 in FIG. 5, the base station may indicate, to the UE, bandwidth part #2 502 with the bandwidth part indicator in the DCI, and the UE may change the bandwidth part to bandwidth part #2 502, indicated with the bandwidth part indicator in the received DCI.

As described above, since DCI-based bandwidth part changing may be indicated by the DCI scheduling PDSCH or physical uplink shared channel (PUSCH), the UE, if receiving a bandwidth part change request, is supposed to be able to receive or transmit the PDSCH or PUSCH, scheduled by the DCI, in the changed bandwidth part without trouble. To that end, the 3GPP standard specified requirements for delay time T_{BWP} required upon changing bandwidth part, which may be defined as follows.

TABLE 9

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 17 |

^{Note 1}
Depends on UE capability.
Note 2:
If the BWP switch involves changing of SCS, the BWP switch delay is determined by the larger one between the SCS before BWP switch and the SCS after BWP switch.

In the 3GPP standard, the requirement for delay of bandwidth part change supports type 1 or type 2 according to the capability of the UE. The UE may report a supportable bandwidth part delay time type to the base station.

If the UE receives, in slot n. DCI including a bandwidth part change indicator according to the above-described requirements for bandwidth part change delay time, the UE may complete a change to the new bandwidth part, indicated by the bandwidth part change indicator, at a time not later than slot n+T_{BWP}, and may perform transmission/reception on the data channel scheduled by the DCI in the changed, new bandwidth part. Upon scheduling data channel in the new bandwidth part, the base station may determine time domain resource allocation for data channel considering the UE's bandwidth part change delay time T_{BWP}. In other words, when scheduling a data channel with the new bandwidth part, in a method for determining a time domain resource allocation for the data channel, the base station may schedule a corresponding data channel after the bandwidth part change delay time. Thus, the UE may not expect that the DCI indicating the bandwidth part change indicates a slot offset (K0 or K2) smaller than the bandwidth part change delay time T_{BWP}.

If the UE has received the DCI (e.g., DCI format 1_1 or 0_1) indicating the bandwidth part change, the UE may perform no transmission or reception during the time period from the third symbol of the slot in which the PDCCH including the DCI has been received to the start point of the slot indicated by the slot offset (K0 or K2) value indicated by the time domain resource allocation indicator field in the DCI. For example, if the UE receives the DCI indicating a bandwidth part change in slot n, and the slot offset value indicated by the DCI is K, the UE may perform no transmission or reception from the third symbol of slot n to a symbol before slot n+K (i.e., the last symbol of slot n+K−1).

Next, a method for configuring transmission/reception-related parameters for each bandwidth part in 5G is described.

The UE may be configured with one or more bandwidth parts by the base station and may further be configured with parameters (e.g., uplink/downlink link data channel and control channel-related configuration information) to be used for transmission/reception for each configured bandwidth part. For example, when the UE is configured with bandwidth part #1 501 and bandwidth part #2 502 in FIG. 5, the UE may be configured with transmission reception parameter #1 for bandwidth part #1 and transmission reception parameter #2 for bandwidth part #2 502. When bandwidth part #1 501 is active, the UE may perform transmission/reception with the base station based on transmission reception parameter #1 and, when bandwidth part #2 502 is active, the UE may perform transmission/reception with the base station based on transmission reception parameter #2.

More specifically, the following parameters may be configured to the UE by the base station.

First, for the uplink bandwidth part, the following information may be configured.

TABLE 10
BWP-Uplink ::= SEQUENCE {

| | |
|---|---|
| bwp-Id | BWP-Id, |

(bandwidth part identifier)

| | |
|---|---|
| bwp-Common | BWP-UplinkCommon OPTIONAL, -- Cond |

```
    SetupOtherBWP
  (cell-specific or common parameter)
```

| | |
|---|---|
| bwp-Dedicated | BWP-UplinkDedicated OPTIONAL, -- Cond SetupOtherBWP |

```
  (UE-specific parameter)
  ...
  }
BWP-UplinkCommon ::= SEQUENCE {
```

| | |
|---|---|
| genericParameters | BWP, |

(normal parameter)

| | |
|---|---|
| rach-ConfigCommon | SetupRelease { RACH-ConfigCommon } OPTIONAL, -- |

```
  Need M
  (random access-related common parameter)
```

| | |
|---|---|
| pusch-ConfigCommon | SetupRelease { PUSCH-ConfigCommon } |

```
    OPTIONAL, -- Need M
  (PUSCH-related common parameter)
```

| | |
|---|---|
| pucch-ConfigCommon | SetupRelease { PUCCH-ConfigCommon } OPTIONAL, |

```
  -- Need M
  (PUSCH-related common parameter)
  ...
  }
BWP-UplinkDedicated ::= SEQUENCE {
```

| | |
|---|---|
| pucch-Config | SetupRelease { PUCCH-Config } OPTIONAL, -- Need |
| M | |

(PUCCH-related UE-specific parameter)

| | |
|---|---|
| pusch-Config | SetupRelease { PUSCH-Config } OPTIONAL, -- Need |

```
    M
  (PUSCH-related UE-specific parameter)
  configuredGrantConfig
```

| | |
|---|---|
| (configured grant-related parameter) | SetupRelease { ConfiguredGrantConfig } |

```
    OPTIONAL, -- Need M
  srs-Config
  (SRS-related parameter)
```

SetupRelease { SRS-Config } OPTIONAL, --

Need M
beamFailureRecoveryConfig

| | |
|---|---|
| (beam failure recovery-related parameter) | SetupRelease |

```
    { BeamFailureRecoveryConfig } OPTIONAL, -- Cond SpCellOnly
  ...
}
```

According to Table 10 described above, the UE may be configured, by the base station, with cell-specific (or cell common or common) transmission-related parameters (e.g., random access channel (RACH), physical uplink control channel (PUCCH), uplink data channel (physical uplink shared channel)-related parameters) (corresponding to BWP-UplinkCommon). Further, the UE may be configured, by the base station, with UE-specific (or dedicated) transmission-related parameters (e.g., PUCCH, PUSCH, non-authorized-based uplink transmission (grant PUSCH), sounding reference signal (SRS)-related parameters) (corresponding to BWP-UplinkDedicated).

Next, for the downlink bandwidth part, the following information may be configured.

TABLE 11
BWP-Downlink ::= SEQUENCE {

| | |
|---|---|
| bwp-Id | BWP-Id, |

(bandwidth part identifier)

| | |
|---|---|
| bwp-Common | BWP-DownlinkCommon OPTIONAL, -- Cond |

```
    SetupOtherBWP
  (cell-specific or common parameter)
```

| | |
|---|---|
| bwp-Dedicated | BWP-DownlinkDedicated OPTIONAL, -- Cond |

```
    SetupOtherBWP
  (UE-specific parameter)
  ...
  }
BWP-DownCommon ::= SEQUENCE {
```

| | |
|---|---|
| genericParameters | BWP, |

(normal parameter)

| | |
|---|---|
| pdcch-ConfigCommon | SetupRelease { PDCCH-ConfigCommon } OPTIONAL, |

```
  -- Need M
  (PDCCH-related common parameter)
```

| | |
|---|---|
| pdsch-ConfigCommon | SetupRelease { PDSCH-ConfigCommon } OPTIONAL, |

```
  -- Need M
  (PDSCH-related common parameter)
  ...
  }
BWP-DownDedicated ::= SEQUENCE {
```

| | |
|---|---|
| pdcch-Config | SetupRelease { PDCCH-Config } OPTIONAL, -- Need |

```
    M
  (PDCCH-related UE-specific parameter)
```

| | |
|---|---|
| pdsch-Config | SetupRelease { PDSCH-Config } OPTIONAL, -- Need |

```
    M
  (PDSCH-related UE-specific parameter)
  sps-Config
```

| | |
|---|---|
| (SPS-related parameter) | SetupRelease { SPS-Config } OPTIONAL, -- Need M |

radioLinkMonitoringConfig

| | |
|---|---|
| (RLM-related parameter) | SetupRelease { radioLinkMonitoringConfig} OPTIONAL, -- |

```
    Cond SpCellOnly
  ...
  }
```

According to Table 11 described above, the UE may be configured, by the base station, with cell-specific (or cell common or common) reception-related parameters (e.g., physical downlink control channel (PDCCH), downlink data channel (physical downlink shared channel)-related parameters) (corresponding to BWP-DownlinkCommon). Further, the UE may be configured, by the base station, with UE-specific (or dedicated) reception-related parameters (e.g., PDCCH, PDSCH, non-authorized downlink data transmission (semi-persistent scheduled PDSCH), radio link monitoring (RLM)-related parameters) (corresponding to BWP-UplinkDedicated).

As a way to support high-speed data services, the data rate may be increased through a spatial multiplexing method using a plurality of transmission/reception antennas. In general, the number of required power amplifiers (PAS) also increases in proportion to the number of transmission antennas provided in the base station or UE. The maximum output of the base station and the UE depends on the power amplifier characteristics, and in general, the maximum output of the base station depends on the cell size covered by the base station. The maximum output is usually expressed in dBm. The maximum output of the UE is usually 23 dBm or 26 dBm.

As an example of a commercial 5G base station, the base station has 64 transmission antennas and corresponding 64 power amplifiers in the 3.5 GHz frequency band and may operate with a bandwidth of 100 MHz. Eventually, the energy consumption of the base station increases in proportion to the output of the power amplifier and the operating time of the power amplifier. As compared to LTE base stations, 5G base stations have a relatively high operation frequency band and are thus characterized by having a wide bandwidth and many transmission antennas. According to these characteristics, there is an effect of increasing the data rate, while the cost of increasing the energy consumption of the base station is incurred. Therefore, the more base stations constituting the mobile communication network, the greater the energy consumption of the entire mobile communication network in proportion thereto.

As described above, the energy consumption of the base station is largely influenced by the power amplifier operation. Since the power amplifier is involved in the base station transmission operation, the downlink (DL) transmission operation of the base station is highly related to the energy consumption of the base station. Relatively, the uplink (UL) reception operation of the base station does not account for a high proportion of the energy consumption of the base station. The physical channels and physical signals transmitted by the base station in the downlink are as follows.
Physical downlink shared channel (PDSCH): A downlink data channel including data to be transmitted to one or more UEs
Physical downlink control channel (PDCCH): A downlink control channel including scheduling information for PDSCH and physical uplink control channel (PUSCH) Or, control information such as slot format or power control command may be transmitted by the PDCCH alone without the PDSCH or PUSCH to be scheduled. The scheduling information includes the resource information mapped with the PDSCH or PUSCH, HARQ-related information, and power control information.
Physical broadcast channel (PBCH): A downlink broadcast channel that provides a master information block (MIB), which is essential system information required data channel and control channel transmission/reception by the UE
Primary synchronization signal (PSS): A signal that serves as a reference for DL time/frequency synchronization and provides part of the information for cell ID
Secondary synchronization signal (SSS): A signal that serves as a reference for DL time and/or frequency (hereinafter, time/frequency) synchronization and provides remaining partial cell ID information
Demodulation reference signal (DM-RS): A reference signal for UE channel estimation for each of PDSCH, PDCCH, and PBCH
Channel-state information reference signal (CSI-RS): A downlink signal that serves as a reference for measuring the downlink channel state of the UE
Phase-tracking reference signal (PT-RS): A downlink signal for phase tracking

When the base station stops the downlink transmission operation from a base station energy saving perspective, the base station energy saving effect due to the suspension of the power amplifier operation may be enhanced. The operation of other base station devices such as baseband devices, as well as the power amplifier is also reduced, enabling additional energy savings. Likewise, although the uplink reception operation occupies a relatively small proportion of the entire energy consumption of the base station, if the base station may stop the uplink reception operation, an additional energy saving effect may be achieved.

The downlink transmission operation of the base station basically depends on the amount of downlink traffic. For example, if there is no data to be transmitted to the UE via downlink, the base station does not need to transmit a PDCCH for scheduling PDSCH and PDSCH. Alternatively, if the transmission may be temporarily suspended for reasons such as that the data is not sensitive to transmission delay, the base station may not perform PDSCH or/and PDCCH transmission. For convenience of description below, a method for reducing base station energy consumption by not transmitting PDSCH or/and PDCCH related to data traffic or adjusting the transmission appropriately is called ‘base station energy saving method 1-1’.

On the other hand, physical channels and physical signals such as PSS, SSS, PBCH, and CSI-RS are repeatedly transmitted at predetermined agreed periods regardless of data transmission to the UE. Therefore, the UE may continuously update downlink time/frequency synchronization, downlink channel state, radio link quality, or the like, even if it does not receive data. In other words, the PSS, SSS, PBCH, and CSI-RSs must be transmitted to the downlink regardless of downlink data traffic, thereby causing energy consumption of the base station. Therefore, base station energy saving may be achieved by controlling the transmission of the signal unrelated to data traffic (or less relevant) to occur less frequently (hereinafter referred to as ‘base station energy saving method 1-2’).

Through the ‘base station energy saving method 1-1’ or ‘base station energy saving method 1-2’, the base station's energy saving effect may be maximized by stopping or minimizing the operation of the base station's power amplifier and the operation of related RF devices and baseband devices during the time period when the base station does not transmit downlink.

As another method, it is possible to reduce the energy consumption of the base station by turning off some of the antennas or power amplifiers of the base station (hereinafter referred to as ‘base station energy saving method 2′’). In this case, as a reaction to the energy-saving effect of the base station, adverse effects such as a decrease in cell coverage or a decrease in throughput may be accompanied. For example, when the base station including 64 transmission antennas and corresponding 64 power amplifiers in the 3.5 GHz frequency band and operating in the 100 MHz bandwidth as described above activates only four transmission antennas and four power amplifiers for a predetermined time interval and switches off the rest for a predetermined time interval, base station energy consumption for the time interval is reduced to about 1/16 (=4/64) but, due to a decrease in maximum transmission power and a decrease in beamforming gain, has difficulty in achieving the cell coverage and throughput when the 64 antennas and power amplifiers are assumed.

In the following description, to be distinguished from the normal base station operation, a base station mode of applying an operation for energy saving in the base station is referred to as a base station energy saving mode (ES mode), and a base station mode of applying the normal base station operation is referred to as a normal mode. The terms for distinguishing the operation modes referred to as the base station normal mode and the base station energy saving mode are for convenience of description, and the disclosure is not limited to the terms, but various terms for distinguishing the operation modes of the base station, such as the first mode and the second mode, may be used.

As another way to support high-speed data services, it is possible to support signal transmission/reception of ultra-wide bandwidths of tens to hundreds of MHz or several GHz in 5G systems. Ultra-wideband signal transmission/reception may be supported through a single component carrier (CC), or may be supported through carrier aggregation (CA) technology that combines multiple component carriers. When a mobile communication operator fails to secure a frequency of a bandwidth sufficient to provide a high-speed data service as a single component carrier, the carrier aggregation technology may increase the sum of frequency bandwidths by combining/aggregating each component carrier having a relatively small bandwidth and consequently enable a high-speed data service.

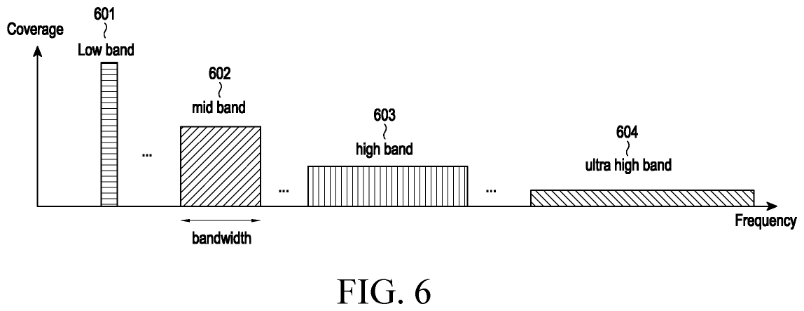

As described above, the frequency band used by the 5G system is wide ranging from several hundred MHz to several tens of GHz. FIG. 6 is a view illustrating a relationship between frequency band, coverage, and bandwidth. Reference numerals 601, 602, 603, and 604 represent examples of frequency bands in the order of the low frequency band to the high frequency band. In general, the lower the frequency band, the greater the coverage due to relatively small path loss, and the higher the frequency band, the smaller the coverage due to relatively high path loss. In the low frequency band, a relatively small number of frequencies are available for mobile communication but, in the high frequency band, it is relatively easy to secure a wide bandwidth frequency to make it appropriate for an ultra-high speed data service. As mobile communication systems evolve, efforts are being made to discover and utilize new frequency bands. For example, although it is still in the early stages of discussion, the 6th generation (6G) mobile communication system, which is a next-generation mobile communication system, considers the THz (Terahertz (1012 Hz) band as one of the candidate frequencies. In general, the mobile communication operator secures several frequency bands and provides a mobile communication service to users. For example, the mobile communication operator may operate a system that combines LTE and 5G by combining the previously secured frequency band for the LTE system and the newly secured frequency band for the 5G system together. As another example, the mobile communication operator may secure frequency bands for a 5G system across several bands and then combine frequencies of several bands to provide a mobile communication service through 5G CA. As described above, since characteristics such as coverage and bandwidth vary according to frequency bands, mobile communication services that combine multiple frequency bands are becoming more popular than mobile communication services that rely on a single frequency band.

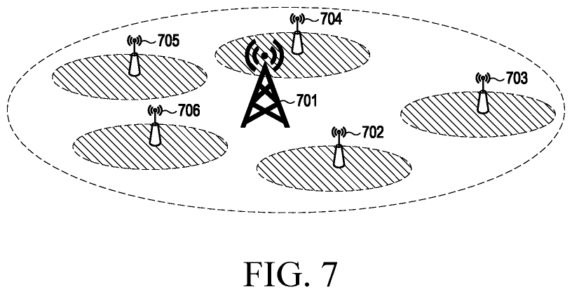

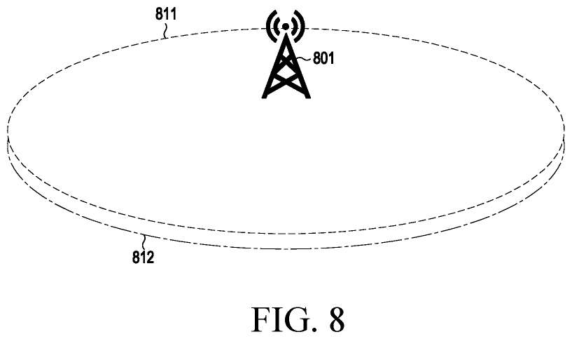

FIGS. 7 and 8 are views illustrating examples of base station deployment scenarios, and illustrate base station deployment scenarios to which the operations of the disclosure are applied.

FIG. 7 illustrates a cell arrangement (F1<F2) in which a carrier operating at a frequency F1 (hereinafter, referred to as a ‘macro cell’ for convenience of description) and a carrier operating at a frequency F1 or F2 (hereinafter, referred to as a ‘small cell’ 702, 703, 704, 705, 706) are arranged. It is assumed that the ‘macrocell’ provides a wide cell coverage due to its relatively high maximum output, while the ‘small cell’ provides a limited cell coverage with a relatively low maximum output. The size of the circle shown in FIG. 7 represents the coverage size that each carrier (or cell) may provide. In the example of FIG. 7, it is illustrated that a plurality of ‘small cells’ coexist within the coverage of the ‘macro cell’. The ‘macrocell’ and ‘smallcell’ are connected wiredly or wirelessly to each other for smooth cooperation. In the disclosure, the base station may have a form in which the ‘macrocell’ and the ‘small cell’ are combined, or the ‘macrocell’ and the ‘small cell’ each may be implemented as a separate base station. If the ‘macrocell’ and ‘small cell’ are implemented as one base station, the ‘macrocell’ and ‘small cell’ each may be referred to as a transmission/reception point (TRP).

The example of FIG. 8 illustrates a carrier aggregation system in which a carrier (cell 1) 811 operating at frequency F1 and a carrier (cell 2) 812 operating at frequency F2 are combined (F1≠F2). The example of FIG. 8 illustrates an example of applying carrier aggregation through one base station 801. Unlike the example of FIG. 7, the example of FIG. 8 illustrates a case in which the cell coverages provided by the respective carriers are the same or similar to each other.

In the disclosure, the transmission bandwidth (or base station BWP) of the signal transmitted by the base station may be adjusted to reduce energy consumption of the base station. In other words, if the base station transmission bandwidth in the base station normal mode is BWₙₒᵣₘₐₗ and the base station transmission bandwidth in the base station energy saving mode is BW_{genergysaving}, the transmission bandwidth of the base station transmission signal may be adjusted to meet the relationship: BWₙₒᵣₘₐₗ>BW_{genergysaving} to reduce the energy consumption of the base station. The above-described ‘base station energy saving method 2’ is a case of turning off the antennas or power amplifiers of the base station, so it may be regarded as a special case in which BW_{energisaving}=0. The units of BWₙₒᵣₘₐₗ and BW_{energysaving} may be expressed in MHz. The base station BWP may be understood as including at least one of the transmission bandwidth of the signal transmitted by the base station and the reception bandwidth of the signal received by the base station.

In the scenario of FIG. 7 or 8, at least one of the plurality of cells constituting the communication system may adjust the transmission bandwidth (or base station BWP) of the base station transmission signal, thereby reducing the energy consumption of the base station. For example, in the case of FIG. 7, by adjusting the transmission bandwidth of at least one ‘small cell’ and maintaining the transmission power of the ‘macro cell’, it is possible to maintain cell coverage through the ‘macro cell’ and reduce the base station energy consumption of the ‘small cell’. In the case of FIG. 8, e.g., by adjusting the transmission bandwidth of cell 2 812 and maintaining the transmission bandwidth of cell 1 811, it is possible to maintain cell coverage and reduce the energy consumption of the base station.

Hereinafter, operations of adjusting the transmission bandwidth of a signal transmitted by a base station or a signal received by the base station proposed in the disclosure are described through specific embodiments of the disclosure.

### First Embodiment

The first embodiment is a method for changing the transmission bandwidth and/or reception bandwidth of the base station, and the base station BWP is described. In the first embodiment, the base station BWP is newly introduced.

In the disclosure, the base station may efficiently use power of the base station by adjusting the bandwidth size and frequency domain position of the base station in the base station BWP as necessary. For example, if the number of UEs served by the base station in the cell is smaller than a certain size, or if the data rate of traffic that the base station should provide to UEs in the cell is smaller than a certain size, the base station may minimize deterioration in performance in the communication system while reducing power consumption at the base station. Conversely, if the number of UEs served by the base station in the cell exceeds a certain size, or if the data rate of traffic that the base station should provide to UEs in the cell exceeds a certain size, the base station may increase the performance of the communication system by changing the base station BWP to a relatively wide bandwidth base station BWP. As described above, the criteria for adjusting the base station BWP may be the number of UEs served by the base station, the data rate of traffic served by the base station, or the like, and predetermined thresholds related thereto may be defined to operate the base station.

In a communication system, the system transmission bandwidth (or referred to as a “system bandwidth”) is the maximum bandwidth a base station may handle, so the bandwidth size of the base station BWP may not be larger than the system transmission bandwidth. The system transmission bandwidth may be included in a system information block (SIB) and provided to the UE. In the first embodiment, as base station BWPs, a base station BWP (‘base station BWP1) of a relatively wide bandwidth for base station operation in the base station normal mode and a base station BWP (‘base station BWP2) of a relatively narrow bandwidth for base station operation in the base station energy saving mode are defined. The higher layer signaling for each base station BWP configuration may include at least one of the configuration information in Table 8, Table 10, and Table 11 described above, and may be configured independently of the BWP configuration information for the UE. The base station may provide the UE with information about the base station BWP change indicating which base station BWP it will operate at, between the configured ‘base station BWP1’ and ‘base station BWP2’ through higher layer signaling (or control information). The information about the base station BWP change may be provided to the UE through higher layer signaling or physical layer signaling (i.e., L1 signaling).

In the disclosure, the UE BWP is a BWP configured to the UE, and is distinguished from the base station BWP. The UE BWP is configured independently for each UE, so that operations in different bandwidths and at different frequency area locations are possible for each UE. When the base station BWP is changed in the disclosure, the base station BWP may be commonly applied to the plurality of UEs in the cell served by the base station. The information about the base station BWP change may be commonly provided to the plurality of UEs so as to be commonly applied to the plurality of UEs in the cell.

In the first embodiment of the disclosure, even if the base station BWP is changed, the UE BWP may be maintained as before. Therefore, the position and size of the frequency area in which the UE actually operates correspond to the overlapping area between the base station BWP and the UE BWP. Further, even if the base station BWP changes, the system transmission bandwidth remains the same.

In the first embodiment, the signal transmitted or received by the base station may be limited to the changed base station BWP. In other words, the base station transmits or receives no signal in the frequency area outside the base station BWP area. In the case of CORESET, which is a time-frequency resource where PDCCH is mapped, in the first embodiment, it may be transmitted in the two methods as follows.

Method 1: When the base station BWP is changed, the PDCCH is mapped according to the existing CORESET configuration while maintaining the existing CORESET configuration for the UE, while only the PDCCH portion included in the changed base station BWP may be transmitted to the UE by the base station.

Method 2: When the base station BWP is changed, the existing CORESET configuration for the UE may be reconfigured according to the changed base station BWP, and the base station may transmit the PDCCH to the UE according to the changed CORESET configuration.

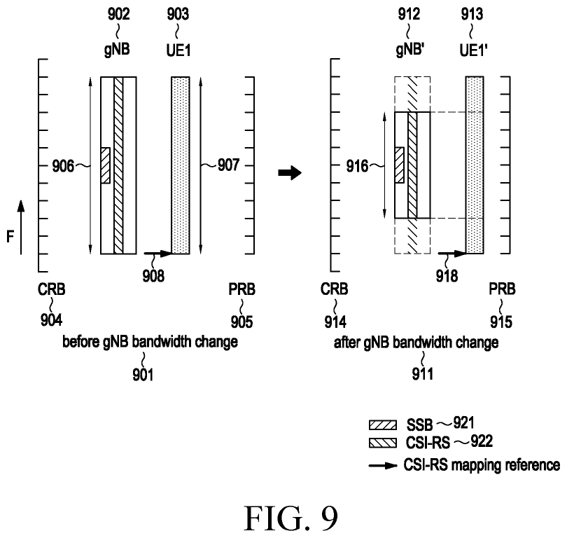

First, the reference numbers/signs of the base stations gNB and gNB′ and the UEs UE and UE′ are shown to be distinguished in the embodiments of FIGS. 9 to 14 to be described below, to indicate that the base station BWP and/or UE BWP configuration of the base station and/or the UE is changed, rather than indicating physically different base stations and different UEs.

FIG. 9 illustrates an example of changing a base station BWP configuration according to the first embodiment of the disclosure.

FIG. 9 illustrates the frequency configurations of a base station (gNB) 902 and a UE (UE1) 903 before the configuration change for the base station BWP, and the frequency configurations of a base station (gNB′) 912 and a UE (UE1′) 913 after the configuration change for the base station BWP. In the example of FIG. 9, the vertical axis represents the frequency area, and before the base station BWP change (901), the system transmission bandwidth and base station BWP are configured like in reference number 906.

In FIG. 9, the system transmission bandwidth or base station BWP configuration is represented with respect to the common resource blocks (CRB) 904, 914, and the UE BWP is represented with respect to the physical resource block (PRB) 905, 915. The common resource blocks 904 and 914 may be shown sequentially indexed in units of resource blocks from a previously agreed frequency area position. The physical resource blocks 905 and 915 may be shown sequentially indexed in units of resource blocks within the UE BWP. Upon the BWP configuration, the base station may inform the UE of relative positions of the common resource block and the physical resource block.

In the example of FIG. 9, the case where the bandwidths of the base station 902 and the UE 903 are the same before the base station BWP change is illustrated (906, 907). In other words, the sizes and frequency area positions of the base station BWP (‘base station BWP1’) 906 and the UE BWP 907 are the same. The SSB 921 transmitted by the base station occupies a relatively small bandwidth, and the CSI-RS 922 occupies a relatively large bandwidth. The mapping reference point of the CSI-RS 922 transmitted by the base station 902 to the UE 903 may be reference number 908, which is the start point of the UE BWP 907.

In the example of FIG. 9, the case where the size of the base station BWP 916 is reduced as shown in reference numeral 916 (‘base station BWP2’) after the base station BWP configuration is changed (911) is illustrated. In this case, the base station 912 may adjust the bandwidth of the signal transmitted to the UE 913 to be within the ‘base station BWP2’ 916. In the example of FIG. 9, the case where even if the base station BWP configuration is changed, the UE BWP configuration remains the same as before the base station BWP change is illustrated (907). Therefore, the mapping of CSI-RS 922 using the start point of the UE BWP as the mapping reference point 918 is not changed, but the CSI-RS transmission bandwidth is changed to be within ‘base station BWP2’ 916, and no signal including CSI-RS is transmitted in an area outside the ‘base station BWP2’ 916.

In the example of FIG. 9, in the position of the UE, the UE BWP configuration remains without change before/after the base station BWP configuration change but, since the base station BWP configuration is changed, the frequency area position and size where the UE 913 operates after the base station BWP configuration change correspond to the ‘base station BWP2’ 916 which is the overlapping area between the base station BWP and the UE BWP.

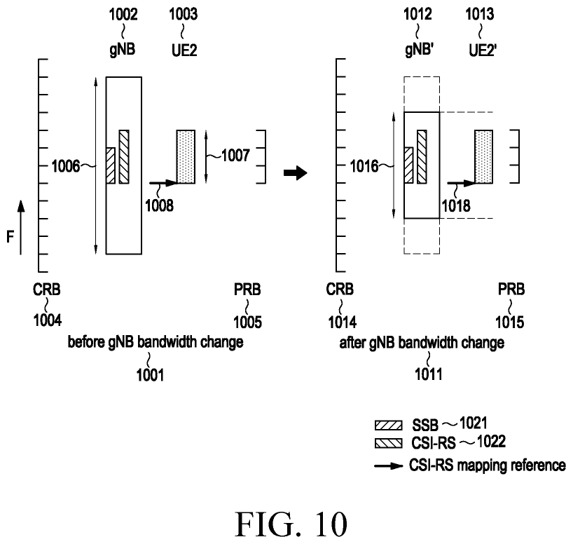

FIG. 10 illustrates another example of changing a base station BWP configuration according to the first embodiment of the disclosure.

FIG. 10 illustrates the frequency configurations of a base station (gNB) 1002 and a UE (UE2) 1003 before the configuration change for the base station BWP, and the frequency configurations of a base station (gNB′) 1012 and a UE (UE2′) 1013 after the configuration change for the base station BWP. In FIG. 10, the vertical axis represents the frequency area, and before the base station BWP change (1001), the system transmission bandwidth and base station BWP are configured like in reference number 1006.

In the example of FIG. 10, the case where the size of the base station BWP 1006 differs from the size of the UE BWP 1007 before the base station BWP change (1001) is illustrated. In other words, the case where the base station BWP (‘base station BWP1’) 1006 includes the UE BWP 1007 is illustrated. The SSB 1021 transmitted by the base station 1002 occupies a relatively small bandwidth, and the CSI-RS 1022 occupies a relatively large bandwidth. The mapping reference point of the CSI-RS 1022 transmitted by the base station 1002 to the UE 1003 may be reference number 1008, which is the start point of the UE BWP 1007.

In the example of FIG. 10, the case where the size of the base station BWP is reduced as shown in reference numeral 1016 (‘base station BWP2’) after the base station BWP configuration is changed (1011) is illustrated. In this case, the base station 1012 may adjust the bandwidth of the signal transmitted to the UE 1013 to be within the ‘base station BWP2’ 1016. In the example of FIG. 10, the case where even if the base station BWP configuration is changed, the UE BWP configuration remains the same as before is illustrated (1007). Therefore, the mapping of CSI-RS 1022 using the start point of the UE BWP as the mapping reference point 1018 is not changed, and the CSI-RS transmission bandwidth becomes within ‘base station BWP2’ 1016, and no signal including CSI-RS is transmitted in an area outside the ‘base station BWP2’ 1016.

In the example of FIG. 10, the UE BWP configuration is not changed, and the base station BWP configuration is changed, but since the overlapping area between the base station BWP 1016 and the UE BWP is the same as the existing UE BWP 1007 before the base station BWP configuration change, the position in the frequency area and size where the UE 1013 operates remain the same.

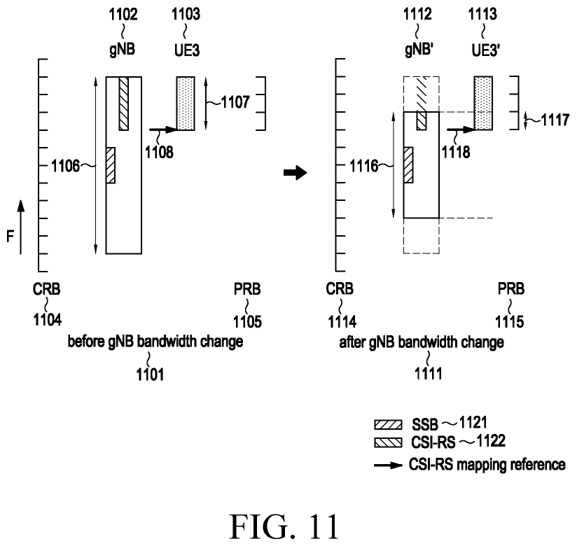

FIG. 11 illustrates another example of changing a base station BWP configuration according to the first embodiment of the disclosure. FIG. 11 illustrates the frequency configurations of a base station (gNB) 1102 and a UE (UE3) 1103 before the configuration change for the base station BWP, and the frequency configurations of a base station (gNB′) 1112 and a UE (UE3′) 1113 after the configuration change for the base station BWP. In the example of FIG. 11, the vertical axis represents the frequency area, and before the base station BWP change (1101), the system transmission bandwidth and base station BWP are configured like in reference number 1106.

In the example of FIG. 11, the case where, before the base station BWP change (1101), the size of the base station BWP 1106 and the UE BWP 1107 differ from each other, and the base station BWP (base station BWP1′) 1106 includes the UE BWP 1107 is illustrated. The SSB 1121 transmitted by the base station 1102 occupies a relatively small bandwidth, and the CSI-RS 1122 occupies a relatively large bandwidth. The mapping reference point of the CSI-RS 1122 transmitted by the base station 1102 to the UE 1103 may be reference number 1108, which is the start point of the UE BWP 1107.

In the example of FIG. 11, the case where the size of the base station BWP is reduced as shown in reference numeral 1116 (‘base station BWP2’) after the base station BWP configuration is changed (1111) is illustrated. In this case, the base station 1112 may adjust the bandwidth of the signal transmitted to the UE 1113 to be within the ‘base station BWP2’ 1116. In the example of FIG. 11, the case where even if the base station BWP configuration is changed, the UE BWP configuration remains the same as before is illustrated (1107). Therefore, the mapping of CSI-RS 1122 using the start point of the UE BWP as the mapping reference point 1118 is not changed, and the CSI-RS transmission bandwidth becomes within ‘base station BWP2’ 1116, and no signal including CSI-RS 1122 is transmitted in an area outside the ‘base station BWP2’ 1116.

In the example of FIG. 11, the case where the UE BWP configuration is not changed, and the base station BWP configuration is changed, and since the overlapping area between the base station BWP 1116 and the UE BWP is limited to a smaller area 1117 than the existing UE BWP 1107 before the base station BWP configuration change (1101) is illustrated. In other words, the size and the position in the frequency area where the UE 1113 operates are limited to be within the overlapping area 1117.

In the example of FIG. 11, if the size of the overlapping area 1117 between the base station BWP 1116 and the UE BWP is smaller than a predetermined threshold so that the transmission/reception operation between the base station 1112 and the UE 1113 is not smooth, it is possible to increase the size of the overlapping area 1117 by exceptionally adjusting the size of the UE BWP to be larger than or equal to the predetermined threshold according to the configuration of the base station 1112. For example, the UE 1113 may adjust the bandwidth and frequency area position of the UE BWP according to the configuration of the base station 1112 according to the changed base station BWP 1116. The predetermined threshold may be set in advance, and be provided to the UE by the base station.

The embodiments of FIGS. 9 to 11 have been described from the viewpoint of base station transmission and UE reception, but the same method may be applied from the viewpoint of base station reception and UE transmission. In the first embodiment described above, the UE may transmit/receive a signal to/from the base station within the overlapping area between the base station BWP and the UE BWP.

In an optional embodiment, in the first embodiment, upon the base station BWP configuration, a predetermined timer value may be additionally set and be provided to the UE by the base station. If the base station BWP is changed, the timer is operated, and if the timer expires, the changed base station BWP may be returned to the previous base station BWP, or a predetermined base station BWP may be configured.

Further, as a modified example of the first embodiment, the mapping reference point of CSI-RS transmitted by the base station to the UE may be set as the start point of the changed base station BWP, rather than the start point of the UE BWP.

### Second Embodiment

The second embodiment is a method for changing the transmission bandwidth and/or reception bandwidth of the base station, and the UE common BWP is described. In the second embodiment, the UE common BWP is newly introduced. In the second embodiment, the transmission bandwidth and/or reception bandwidth of the base station may be referred to as a base station bandwidth or the above-described base station BWP.

Further, in the disclosure, the transmission bandwidth and/or reception bandwidth of the base station, or the base station BWP, may be collectively referred to as a base station bandwidth.

As described above, the existing UE BWP is configured independently for each UE, so that operations in different bandwidths and at different frequency area locations are possible for each UE. To change the base station transmission/reception bandwidth for base station energy saving, it is necessary to keep the UE BWP configuration, such as the frequency area position and bandwidth of the individual UE served by the base station, as dense as possible without being distributed in the frequency area. In other words, a base station energy saving effect may be obtained by configuring a common UE BWP and applying it to all of the UEs in the serving cell of the base station, and allowing the base station to perform transmission/reception operations in the frequency area including the common UE BWP but not in other areas.

The existing UE is configured with a total of N UE BWPs and activates one UE BWP among the N UE BWPs configured by the base station at an arbitrary time to perform transmission/reception operation between the UE and the base station through the activated UE BWP. In order to configure the UE common BWP to the UE according to the second embodiment, the following method is possible.
Method A: The base station may configure N^{(N≥1)} UE BWPs for each UE, as previous and may configure one additional UE common BWP. In this case, the total number of BWPs configured for each UE becomes N+1.
Method B: The base station may configure N−1 UE BWPs for each UE and may configure one UE common BWP. In this case, the total number of BWPs configured for each UE remains the same as N in total.

The frequency area position and bandwidth size of the UE common BWP configured according to the second embodiment are at least the same as the transmission/reception frequency area position and bandwidth of the base station bandwidth to be adjusted by the base station or included in the base station bandwidth range, and the configuration of the UE common BWP may include the configuration information of Table 8, Table 10, and Table 11. The base station may provide signaling information (control information) about a change in the UE BWP that informs the UE of which BWP to operate between the UE BWP configured to the UE and the UE common BWP. The signaling information about the change in the UE BWP may be higher layer signaling or physical layer (L1) signaling. The signaling information indicating a change to the UE common BWP to the UE may be common signaling information commonly applied to the plurality of UEs in the cell of the base station.

As described in the first embodiment, the determination criterion for whether to operate the base station in the normal mode or the base station energy saving mode may be the number of UEs served by the base station, the data rate of traffic served by the base station, or the like, and predetermined thresholds related thereto may be defined and operated. In the second embodiment, the base station bandwidth for the base station to transmit or receive a signal according to the base station energy saving mode may be adjusted to include the changed UE common BWP. Further, the base station does not transmit or receive any signals in the frequency area outside the adjusted base station bandwidth.

According to the second embodiment, the UE common BWP is configured so that CORESET to which the PDCCH is mapped is positioned within the UE common BWP.

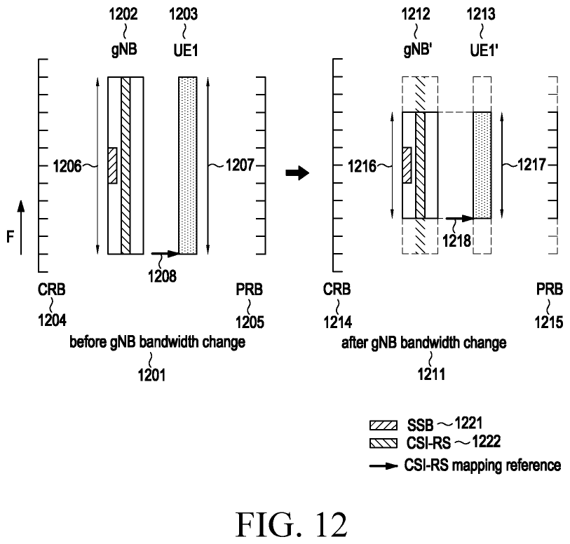

FIG. 12 illustrates an example of applying a UE common BWP and changing a base station bandwidth according to the second embodiment of the disclosure.

FIG. 12 illustrates the frequency configurations of a base station (gNB) 1202 and a UE (UE1) 1203 before the configuration change for the base station bandwidth, and the frequency configurations of a base station (gNB′) 1212 and a UE (UE1′) 1213 after the configuration change (1211) for the base station bandwidth. In the example of FIG. 12, the vertical axis represents the frequency area, and before the base station bandwidth change (1201), the system transmission bandwidth and base station bandwidth are configured like in reference number 1206.

In FIG. 12, the system transmission bandwidth or base station bandwidth configuration is represented with respect to the common resource blocks (CRB) 1204, 1214, and the UE BWP is represented with respect to the physical resource block (PRB) 1205, 1215. The common resource blocks 1204 and 1214 may be shown sequentially indexed in units of resource blocks from a previously agreed frequency area position. The physical resource blocks 1205 and 1215 may be shown sequentially indexed in units of resource blocks within the UE BWP. Upon the BWP configuration, the base station may inform the UE of relative positions of the common resource block and the physical resource block.

In the example of FIG. 12, the case where the bandwidths of the base station 1202 and the UE 1203 are the same before the base station bandwidth change/adjustment (1201) is illustrated (1206, 1207). In other words, the sizes and frequency area positions of the base station bandwidth 1206 and the UE BWP 1207 are the same. The SSB 1221 transmitted by the base station occupies a relatively small bandwidth, and the CSI-RS 1222 occupies a relatively large bandwidth. The mapping reference point of the CSI-RS 1222 transmitted by the base station 1202 to the UE 1203 may be reference number 1208, which is the start point of the UE BWP 1207.

In the example of FIG. 12, the case where the UE BWP 1207 is reduced according to the UE common BWP configuration as in the example of reference numeral 1217 is illustrated. Further, the case where the size of the base station bandwidth 1206 is accordingly reduced as in the example of reference numeral 1216 is illustrated. In the example of FIG. 12, the case where the size of the adjusted base station bandwidth 1216 and the size of the UE common BWP 1217 are the same is illustrated. Accordingly, the base station 1212 may transmit a signal to the UE 1213 within the adjusted base station bandwidth 1216.

The example of FIG. 12 is the case where the start point of the UE BWP 1217 is changed, and accordingly, the mapping of the CSI-RS 1222 may also be changed with respect to the new mapping reference point 1218. Further, the bandwidth for transmission of the CSI-RS 1222 may be changed/adjusted to be within the adjusted base station bandwidth 1216. In other words, no signal including the CSI-RS 1222 is transmitted in the area outside the adjusted base station bandwidth 1216.

From the UE's perspective, since the UE BWP configuration has been changed to the UE common BWP 1217, the size and frequency area position where the UE 1213 operates are also limited to be within the UE common BWP 1217.

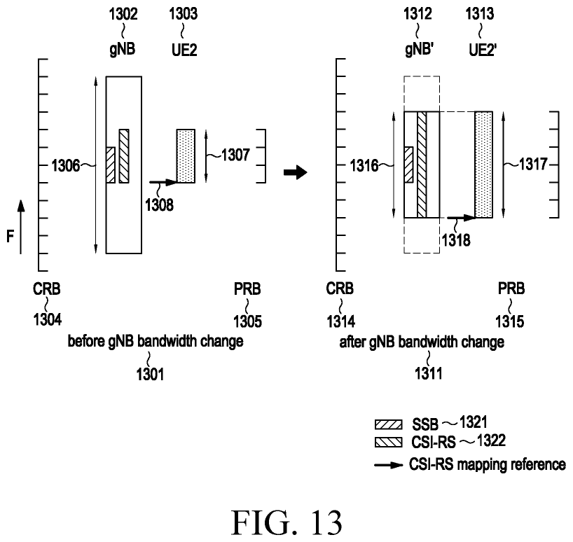

FIG. 13 illustrates another example of applying a UE common BWP and changing a base station bandwidth according to the second embodiment of the disclosure.

FIG. 13 illustrates the frequency configurations of a base station (gNB) 1302 and a UE (UE2) 1303 before the configuration change for the base station bandwidth, and the frequency configurations of a base station (gNB′) 1312 and a UE (UE2′) 1313 after the base station bandwidth change (1311). In the example of FIG. 13, the vertical axis represents the frequency area, and before the base station bandwidth change (1301), the system transmission bandwidth and base station bandwidth are configured like in reference number 1306.

In the example of FIG. 13, the case where, before the base station bandwidth change/adjustment (1301), the sizes of the base station bandwidth 1306 and the UE BWP 1307 differ from each other, and the base station bandwidth 1306 includes the UE BWP 1307 is illustrated. The SSB 1321 transmitted by the base station 1302 occupies a relatively small bandwidth, and the CSI-RS 1322 occupies a relatively large bandwidth. The mapping reference point of the CSI-RS 1322 transmitted by the base station 1302 to the UE 1303 may be reference number 1308, which is the start point of the UE BWP 1307.

In the example of FIG. 13, the case where the UE BWP 1307 is enlarged according to the UE common BWP configuration as in the example of reference numeral 1317 is illustrated. Further, the case where the size of the base station bandwidth 1306 is accordingly reduced as in the example of reference numeral 1316 is illustrated. In the example of FIG. 13, the case where the size of the adjusted base station bandwidth 1316 and the size of the UE common BWP 1317 are the same is illustrated. Accordingly, the base station 1312 may transmit a signal to the UE 1313 within the adjusted base station bandwidth 1316.

The example of FIG. 13 is the case where the start point of the UE BWP 1317 is changed, and accordingly, the mapping of the CSI-RS 1322 may also be changed with respect to the new mapping reference point 1318. Further, the bandwidth for transmission of the CSI-RS 1322 is changed to be within the adjusted base station bandwidth 1316. In other words, no signal including the CSI-RS 1322 is transmitted in the area outside the adjusted base station bandwidth 1316.

From the UE's perspective, since the UE BWP configuration has been changed to the UE common BWP 1317, the size and frequency area position where the UE 1313 operates are also limited to be within the UE common BWP 1317.

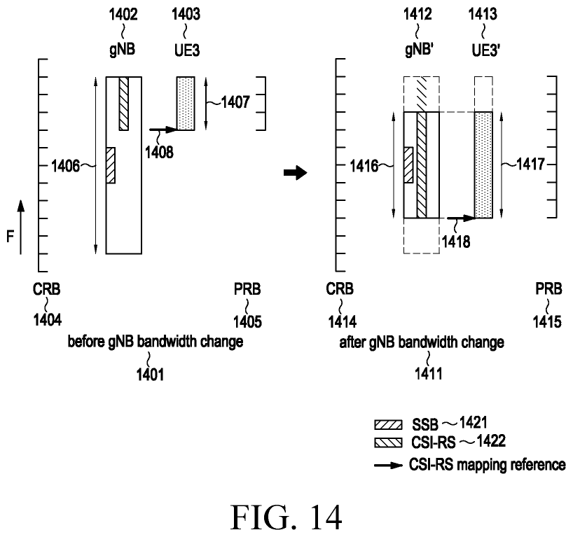

FIG. 14 illustrates another example of applying a UE common BWP and changing a base station bandwidth according to the second embodiment of the disclosure.

FIG. 14 illustrates the frequency configurations of a base station (gNB) 1402 and a UE (UE3) 1403 before the configuration change (1401) for the base station bandwidth, and the frequency configurations of a base station (gNB′) 1412 and a UE (UE3′) 1413 after the configuration change (1411) for the base station bandwidth. In the example of FIG. 14, the vertical axis represents the frequency area, and before the base station bandwidth change (1401), the system transmission bandwidth and base station bandwidth are configured like in reference number 1406.

In the example of FIG. 14, the case where, before the base station bandwidth change/adjustment (1401), the sizes of the base station bandwidth 1406 and the UE BWP 1407 differ from each other, and the base station bandwidth 1406 includes the UE BWP is illustrated. The SSB 1421 transmitted by the base station 1402 occupies a relatively small bandwidth, and the CSI-RS 1422 occupies a relatively large bandwidth. The mapping reference point of the CSI-RS 1422 transmitted by the base station 1402 to the UE may be reference number 1408, which is the start point of the UE BWP 1407.

In the example of FIG. 14, the case where the UE BWP 1407 is changed/adjusted according to the UE common BWP configuration as in the example of reference numeral 1417 is illustrated. Further, the case where the size of the base station bandwidth 1406 is accordingly reduced as in the example of reference numeral 1416 is illustrated. In the example of FIG. 14, the case where the size of the adjusted base station bandwidth 1416 and the size of the UE common BWP 1417 are the same is illustrated. Accordingly, the base station 1412 may transmit a signal to the UE 1413 within the adjusted base station bandwidth 1316.

The example of FIG. 14 is the case where the start point of the UE BWP 1407 is changed, and accordingly, the mapping of the CSI-RS 1422 may also be changed with respect to the new mapping reference point 1418. Further, the bandwidth for transmission of the CSI-RS 1422 is changed to be within the adjusted base station bandwidth 1416. In other words, no signal including the CSI-RS 1422 is transmitted in the area outside the adjusted base station bandwidth 1416.

From the UE's perspective, since the UE BWP configuration has been changed to the UE common BWP 1417, the size and frequency area position where the UE 1413 operates are also limited to be within the UE common BWP 1417.

The embodiments of FIGS. 12 to 14 have been described from the viewpoint of base station transmission and UE reception, but the same method may be applied from the viewpoint of base station reception and UE transmission. In the second embodiment described above, the UE may transmit/receive a signal to/from the base station within the overlapping area between the base station bandwidth and the UE common BWP.

In an optional embodiment, in the second embodiment, in relation to the base station bandwidth change, a predetermined timer value may be additionally set and be provided to the UE by the base station. If the base station bandwidth is changed, the timer is operated, and if the timer expires, the changed base station bandwidth may be returned to the previous base station bandwidth, or a predetermined base station bandwidth may be configured.

Further, as a modified example of the second embodiment, the mapping reference point of CSI-RS transmitted by the base station to the UE may be set as the start point of the changed base station bandwidth, rather than the start point of the UE BWP.

### Third Embodiment

The third embodiment is a method for changing the transmission bandwidth and/or reception bandwidth of the base station, and a method for changing the base station system bandwidth is described.

In general, the system transmission bandwidth in a communication system is maintained as a fixed value once set, and the third embodiment proposes an operation of changing the system transmission bandwidth during the base station energy saving mode operation. In other words, a base station energy saving effect may be obtained by operating with the existing system transmission bandwidth in the base station normal mode, and changing/adjusting to a system transmission bandwidth relatively smaller than the existing system transmission bandwidth in the base station energy saving mode. Control information indicating the system transmission bandwidth may be included in the system information block (SIB) and provided from the base station to the UE. Therefore, when changing the system transmission bandwidth, the base station may update the system information and provide it to the UE.

For base station energy saving, the first embodiment proposes a method for changing the base station BWP proposed in the disclosure while maintaining the system transmission bandwidth. The third embodiment proposes a method for changing the system transmission bandwidth. According to the third embodiment, the signal transmitted or received by the base station may be limited to be within the changed system transmission bandwidth. In other words, the base station transmits or receives no signal in the frequency area outside the system transmission bandwidth. In the case of CORESET to which the PDCCH is mapped, ‘method 1’ and ‘method 2’ proposed in the first embodiment may be similarly applied to the third embodiment. However, in the third embodiment, the ‘base station BWP’ described in the first embodiment is replaced with the ‘system transmission bandwidth’.

In the third embodiment, even if the system transmission bandwidth is changed, the UE BWP remains the same as before. Therefore, the position and size in the frequency area in which the UE actually operates correspond to the overlapping area between the changed system transmission bandwidth and the UE BWP.

The mapping reference point of the CSI-RS transmitted by the base station to the UE may follow the start point of the UE BWP or the start point of the system transmission bandwidth.

### Fourth Embodiment

The fourth embodiment describes a method for mapping a reference signal when the transmission bandwidth and/or reception bandwidth of the base station is changed. The transmission bandwidth and/or reception bandwidth of the base station may be referred to as a base station bandwidth.

In the first, second, and third embodiments, the mapping reference point of the CSI-RS transmitted by the base station to the UE is the start point of the UE BWP (or the start point of the UE common BWP), but in the fourth embodiment, the mapping reference point of the CSI-RS may be the start point of the existing base station bandwidth (method A) or the start point of the changed base station bandwidth (or base station BWP) (method B).

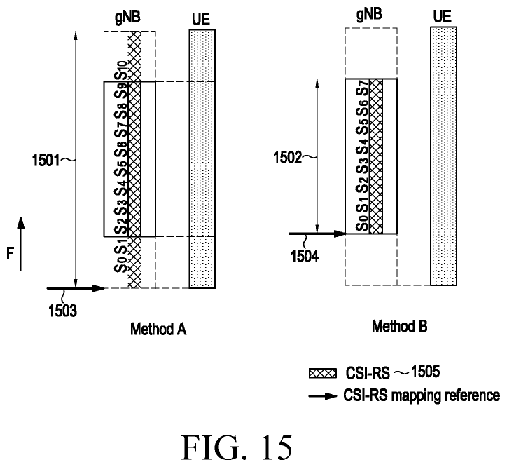

Hereinafter, a CSI-RS mapping method when the base station transmission bandwidth is changed is described with reference to FIG. 15. FIG. 15 illustrates a case where the base station bandwidth is equal to reference number 1501 in the base station normal mode, the base station bandwidth is equal to reference number 1502 in the base station energy saving mode, and the UE BWP bandwidth is equal to the base station bandwidth 1501.

In the method A for mapping CSI-RS when the base station bandwidth changes, the start point 1503 of the base station bandwidth in the base station normal mode is used as the mapping reference point of the CSI-RS 1505. In the base station normal mode, the lowest subcarrier index of the frequency area may be used as the start point of the base station bandwidth. For example, if the sequence of the CSI-RS 1505 mappable to the base station bandwidth 1501 is [s₀, s₁, s₂, s₃, s₄, s₅, s₆, s₇, s₈, s₉, s₁₀], the method A sets the mapping reference point of the CSI-RS 1505 as the start point 1503 of the base station bandwidth in the base station normal mode and may thus map the CSI-RS 1505 sequentially from the start sample so of the CSI-RS sequence, from the start point 1503. Further, the base station may actually transmit the CSI-RS sequence [s₂, s₃, s₄, s₅, s₆, s₇, s₈, s₉] corresponding to the changed base station bandwidth 1502 to the UE.

When the base station bandwidth is changed, in the method B of mapping the CSI-RS 1505, the start point 1504 of the changed base station bandwidth 1502 in the base station energy saving mode may be set as the mapping reference point of the CSI-RS 1505. The lowest subcarrier index in the frequency area of the changed base station bandwidth 1502 may be used as the CSI-RS mapping start point. For example, it the sequence of the CSI-RS 1505 mappable to the changed base station bandwidth 1502 is [s₀, s₁, s₂, s₃, s₄, s₅, s₆, s₇], the method B sets the mapping reference point of the CSI-RS 1505 as the start point 1504 of the changed base station bandwidth 1502, and may thus map the CSI-RS 1505 sequentially from the start sample so of the CSI-RS sequence from the start point 1504 and actually transmit, to the UE, the CSI-RS sequence [s₀, s₁, s₂, s₃, s₄, s₅, s₆, s₇] corresponding to the changed base station bandwidth 1502.

Although the CSI-RS is described as an example in the fourth embodiment, the method described in the fourth embodiment may be applied to transmission of reference signals other than the CSI-RS.

### Fifth Embodiment

In the fifth embodiment, an example of a UE procedure and a base station procedure according to an embodiment of the disclosure is described. The UE procedure and the base station procedure of the fifth embodiment may be performed in combination with at least one of the first to fourth embodiments.

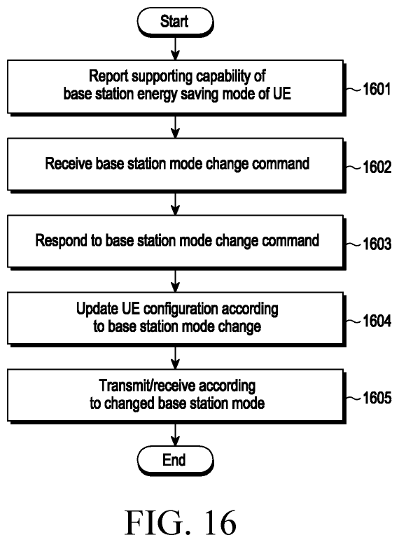

FIG. 16 is a view illustrating an example of a UE procedure of applying a case where a base station switches to/operates in a base station energy saving mode or a base station normal mode according to an embodiment of the disclosure.

Referring to FIG. 16, in step 1601, the UE reports UE capability information including the supporting capability for the base station energy saving mode to the base station. For example, the UE capability information may include at least one of capability information related to the base station energy saving mode, such as information indicating whether the UE supports the base station energy saving mode, frequency band-related information supported by the UE, and channel bandwidth-related information supported by the UE.

Thereafter, in step 1602, if the UE successfully receives/obtains signaling information to change the base station mode from the base station normal mode to the base station energy saving mode, the UE performs a UE configuration change according to the base station energy saving mode indicated by the base station. For example, the signaling information may include at least one of configuration information related to the base station energy saving mode, such as information about the base station bandwidth (or base station BWP) changed according to the base station energy saving mode, and configuration information about the physical channel and/or physical channel signal whose transmission characteristics are changed.

Alternatively, the UE may receive signaling information to change from the base station energy saving mode to the base station normal mode from the base station in step 1602. In this case, the signaling information may include at least one of configuration information related to the base station normal mode, such as information about the base station bandwidth (or base station BWP) changed according to the base station normal mode, and configuration information about the physical channel and/or physical channel signal whose transmission characteristics are changed. Further, as described above, the signaling information may be provided to the UE through higher layer signaling information such as RRC information and/or L1 signaling information such as DCI. Further, at least one of the information that may be included in the signaling information for changing the base station mode may be pre-configured to the UE by higher layer signaling.

When the UE successfully receives/obtains the ‘signaling information about the base station mode change’ in step 1602, the UE transmits a ‘response to the base station mode change’ to the base station in step 1603. The transmission of the response may be omitted.

In step 1604, the UE may update the related UE configuration according to the ‘base station mode change’. For example, the UE receiving the signaling information about the base station mode change may complete changes to the configuration of the hardware such as the radio frequency (RF) device or baseband device operating in the UE and/or software configuration. From step 1605, the UE performs a transmission/reception operation according to the changed base station mode. Specific UE transmission/reception operations according to the base station mode follows the above-described embodiments.

The above-described steps may be omitted, changed in order, or add a step not described when the disclosure is performed.

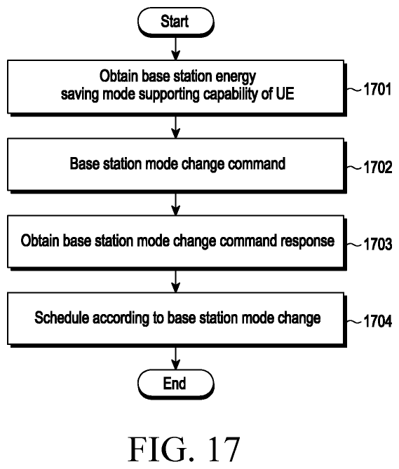

FIG. 17 is a view illustrating an example of a base station procedure of applying a case where a base station switches to/operates in a base station energy saving mode or a base station normal mode according to an embodiment of the disclosure.

Referring to FIG. 17, in step 1701, the base station receives/obtains UE capability information including the supporting capability for the base station energy saving mode from the UE. For example, the UE capability information may include at least one of capability information related to the base station energy saving mode, such as information indicating whether the UE supports the base station energy saving mode, frequency band-related information supported by the UE, and channel bandwidth-related information supported by the UE.

Thereafter, in step 1702, the base station performing the mode change transmits ‘signaling information about the base station mode change’ to the UE. When the signaling information is information indicating to change from the base station normal mode to the base station energy saving mode, the signaling information may include, e.g., at least one of configuration information related to the base station energy saving mode, such as information about the base station bandwidth (or base station BWP) changed according to the base station energy saving mode, and configuration information about the physical channel and/or physical channel signal whose transmission characteristics are changed.

Alternatively, when the signaling information is signaling information indicating to change from the base station energy saving mode to the base station normal mode in step 1702, the signaling information may include at least one of configuration information related to the base station normal mode, such as information about the base station bandwidth (or base station BWP) changed according to the base station normal mode, and configuration information about the physical channel and/or physical channel signal whose transmission characteristics are changed. Further, as described above, the signaling information may be provided to the UE through higher layer signaling information such as RRC information and/or L1 signaling information such as DCI. Further, at least one of the information that may be included in the signaling information for changing the base station mode may be pre-configured to the UE by higher layer signaling.

In step 1703, the base station successfully receives a ‘response to the base station mode change’ from the UE. Step 1703 may be omitted.

In step 1704, the base station performs a scheduling operation according to the changed base station mode. For example, the base station in the base station energy saving mode may adjust the base station bandwidth (or base station BWP) according to the base station energy saving mode, and transmit a downlink signal to the UE in the adjusted base station bandwidth (or base station BWP). Specific base station transmission/reception operations according to the base station mode follows the above-described embodiments.

The above-described steps may be omitted, changed in order, or add a step not described when the disclosure is performed.

Further, an example of the methods described in FIGS. 16 and 17 may be performed in combination with at least one of the first to fourth embodiments.

A UE (hereinafter, referred to as UE A) that supports the UE operation according to the base station energy saving mode and a UE that does not (hereinafter, referred to as UE B) may coexist in the cell served by the base station operating as described above. In the case of UE A, the UE operation according to at least one of the first to fourth embodiments described above may be performed. In the case of the UE B, since it cannot respond to a change in the base station transmission scheme according to the base station energy saving mode, there may be a concern of performance degradation in transmission efficiency, cell capacity, throughput, UE power consumption, or the like. Therefore, if the base station may discern whether it is UE A or UE B based on the UE capability report of the UE, additional operations may be performed to prevent performance deterioration of UE B. For example, the base station may hand over UE B to an adjacent cell with the base station in the base station normal mode state, rather than the current cell to be switched to the base station energy saving mode.

Various changes may be made to the fifth embodiment. For example, a procedure of omitting the step of reporting UE capability to the base station by the UE is also possible.

As another modified example of the fifth embodiment, a method in which the base station operates without separately notifying the UE of the ‘signaling information about the base station mode change’ is also possible. In other words, the UE may perform transmission/reception operation merely according to base station scheduling without the need for discerning whether the current base station is in the base station normal mode or the base station energy saving mode.

According to embodiments of the disclosure, it is possible to save excessive energy consumption and achieve high energy efficiency by changing/adjusting/configuring the bandwidth of at least one of a base station and a UE for energy saving in a wireless communication system and proposing a communication method between the base station and the UE.

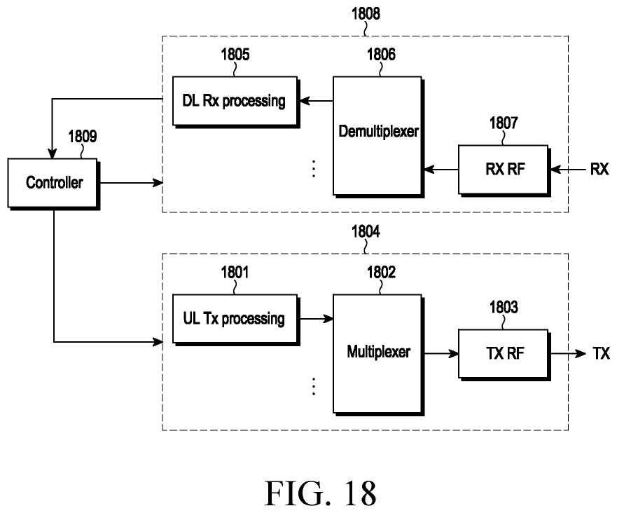

FIG. 18 is a view illustrating an example of a configuration of a UE performing transmission/reception in a wireless communication system according to an embodiment of the disclosure. For convenience of description, devices not directly related to the disclosure may be neither shown nor described.

Referring to FIG. 18, a UE may include a transmitter 1804 including an uplink transmission processing block 1801, a multiplexer 1802, and a transmission RF block 1803, a receiver 1808 including a downlink reception processing block 1805, a demultiplexer 1806, and a reception RF block 1807, and a controller 1809. As described above, the controller 1809 may control the operation of the receiver 1808 for receiving a downlink signal in the data channel and/or the control channel, and may control the operation of the transmitter 1804 for transmitting an uplink signal.

In the transmitter 1804 of the UE, the uplink transmission processing block 1801 may generate a signal to be transmitted by performing processes such as channel coding and modulation. The signal generated by the uplink transmission processing block 1801 may be multiplexed with another uplink signal by the multiplexer 1802, signal-processed by the transmission RF block 1803, and then transmitted to the base station.

The receiver 1808 of the UE demultiplexes the signal received from the base station and distributes the signal to each downlink reception processing block. The downlink reception processing block 1805 may obtain the control information or data transmitted by the base station by performing processes such as demodulation and channel decoding on the downlink signal of the base station. The receiver 1808 of the UE may support the operation of the controller 1809 by transferring the output result of the downlink reception processing block to the controller 1809.

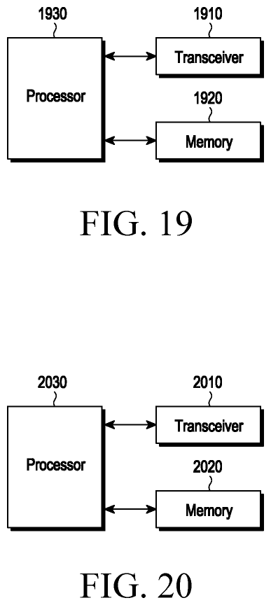

FIG. 19 is a block diagram illustrating an example of a configuration of a UE according to an embodiment of the disclosure.

Referring to FIG. 19, a UE according to the disclosure may include a processor 1930, a transceiver 1910, and memory 1920. However, the components of the UE are not limited thereto. For example, the UE may include more or fewer components than the above-described components. The processor 1930, the transceiver 1910, and the memory 1920 may be implemented in the form of a single chip. According to an embodiment, the transceiver 1910 of FIG. 19 may include the transmitter 1804 and the receiver 1808 of FIG. 18. The transceiver 1910 of FIG. 19 may be referred to as a transmission/reception unit for transmitting/receiving radio signals. Further, the processor 1530 of FIG. 19 may include the controller 1809 of FIG. 18.

According to an embodiment, the processor 1930 may control a series of processes for the UE to be able to operate according to the above-described embodiments. For example, according to at least one of the first to fifth embodiments of the disclosure, it is possible to control the components of the UE to perform a transmission/reception method of the UE according to whether a base station mode is a base station energy saving mode or a base station normal mode. There may be provided one or more processors 1930. The processor 1930 may perform the transmission/reception operation of the UE in the wireless communication system which applies carrier aggregation according to the disclosure described above by executing a program stored in the memory 1920.

The transceiver 1910 may transmit and receive signals to/from a base station. The transmitted/received signals with the base station may include at least one of control information and data. The transceiver 1910 may include an RF transmitter for frequency-up converting and amplifying signals transmitted and an RF receiver for low-noise amplifying signals received and frequency-down converting the frequency of the received signals. However, this is merely an example of the transceiver 1910, and the components of the transceiver 1910 are not limited to the RF transmitter and the RF receiver. The transceiver 1910 may receive signals via a radio channel, output the signals to the processor 1930, and transmit signals output from the processor 1930 via a radio channel.

According to an embodiment, the memory 1920 may store programs and data necessary for the operation of the UE according to at least one of the first embodiment to the fifth embodiment. The memory 1920 may store control information or data that is included in the signal transmitted/received by the UE. The memory 1920 may include a storage medium, such as ROM, RAM, hard disk, CD-ROM, and DVD, or a combination of storage media. There may be provided a plurality of memories 1920. According to an embodiment, the memory 1920 may store a program for performing a transmission/reception operation of a UE according to whether a base station mode is a base station energy saving mode or a base station normal mode which is the above-described embodiments of the disclosure.

FIG. 20 is a block diagram illustrating an example of a configuration of a base station according to an embodiment of the disclosure.

Referring to FIG. 20, a base station according to the disclosure may include a processor 2030, a transceiver 2010, and memory 2020. However, the components of the base station are not limited thereto. For example, the base station may include more or fewer components than the above-described components. The processor 2030, the transceiver 2010, and the memory 2020 may be implemented in the form of a single chip. The transceiver 2010 of FIG. 20 may be referred to as a transmission/reception unit for transmitting/receiving radio signals.

The processor 2030 may control a series of processes for the base station to be able to operate according to the above-described embodiments. For example, according to at least one of the first to fifth embodiments of the disclosure, it is possible to control the components of the base station to perform a method for scheduling a UE according to whether a base station mode is a base station energy saving mode or a base station normal mode. There may be provided one or more processors 2030. The processor 2030 may perform a method for scheduling the UE according to whether the above-described base station mode of the disclosure is the base station energy saving mode or the base station normal mode by executing the program stored in the memory 2020.

The transceiver 2010 may transmit and receive signals to/from a UE. The transmitted/received signals with the UE may include at least one of control information and data. The transceiver 2010 may include an RF transmitter for frequency-up converting and amplifying signals transmitted and an RF receiver for low-noise amplifying signals received and frequency-down converting the frequency of the received signals. However, this is merely an example of the transceiver 2010, and the components of the transceiver 2010 are not limited to the RF transmitter and the RF receiver. The transceiver 2010 may receive signals via a radio channel, output the signals to the processor 2030, and transmit signals output from the processor 2030 via a radio channel.

According to an embodiment, the memory 2020 may store programs and data necessary for the operation of the base station according to at least one of the first embodiment to the fifth embodiment. Further, the memory 2020 may store control information or data that is included in the signal transmitted/received by the base station. The memory 2020 may include a storage medium, such as ROM, RAM, hard disk, CD-ROM, and DVD, or a combination of storage media. There may be provided a plurality of memories 1620. According to an embodiment, the memory 2020 may store a program for performing a method for scheduling the UE according to whether a base station mode is a base station energy saving mode or a base station normal mode which is the above-described embodiments of the disclosure.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although preferred embodiments of the disclosure have been shown and described in connection with the drawings and particular terms have been used, this is to provide a better understanding of the disclosure and is not intended to limit the scope of the disclosure. It is apparent to one of ordinary skill in the art that various changes may be made thereto without departing from the scope of the disclosure. Further, the embodiments may be practiced in combination.

Although specific embodiments of the disclosure have been described above, various changes may be made thereto without departing from the scope of the disclosure. Thus, the scope of the disclosure should not be limited to the above-described embodiments, and should rather be defined by the following claims and equivalents thereof.

1-15. (canceled)

16. A method performed by a base station for energy saving in a wireless communication system, the method comprising:
transmitting configuration information about base station bandwidth parts (BWPs) including a first base station BWP and a second base station BWP that is smaller than the first base station BWP;
transmitting, to a user equipment (UE), control information indicating a BWP change to the first base station BWP or the second base station BWP; and
communicating with the UE in an overlapping area of the second base station BWP and a UE BWP configured for the UE in case that the control information indicates the BWP change to the second base station BWP.

17. The method of claim 16, wherein a size of the base station BWPs is smaller than or equal to a system bandwidth of the base station, and
wherein the base station transmits at least one of a synchronization signal (SSB)/physical broadcast channel (PBCH) block or a reference signal in the overlapping area.

18. The method of claim 16, wherein, in case that the second base station BWP is smaller than the UE BWP, the base station does not transmit a signal to the UE in an area outside the second base station BWP.

19. The method of claim 16, wherein a mapping reference point of a reference signal transmitted by the base station, to the UE, is configured based on one start point among the UE BWP, the first base station BWP, or the second base station BWP in a frequency domain.

20. A base station in a wireless communication system, the base station comprising:
a transceiver; and
a processor configured to:
transmit, through the transceiver, configuration information about base station bandwidth parts (BWPs) including a first base station BWP and a second base station BWP that is smaller than the first base station BWP,
transmit, to a user equipment (UE), through the transceiver, control information indicating a BWP change to the first base station BWP or the second base station BWP, and
communicate with the UE, through the transceiver, in an overlapping area of the second base station BWP and a UE BWP configured for the UE, in case that the control information indicates the BWP change to the second base station BWP.

21. The base station of claim 20, wherein a size of the base station BWPs is smaller than or equal to a system bandwidth of the base station, and
wherein the processor is further configured to transmit, through the transceiver, at least one of a synchronization signal (SSB)/physical broadcast channel (PBCH) block or a reference signal in the overlapping area.

22. The base station of claim 20, wherein, in case that the second base station BWP is smaller than the UE BWP, the processor is configured not to transmit a signal to the UE in an area outside the second base station BWP.

23. The base station of claim 20, wherein a mapping reference point of a reference signal transmitted by the base station, to the UE, is configured based on one start point among the UE BWP, the first base station BWP, or the second base station BWP in a frequency domain.

24. A user equipment (UE) in a wireless communication system, comprising:
a transceiver; and
a processor configured to:
receive, through the transceiver, from a base station, configuration information about base station bandwidth parts (BWPs) including a first base station (BWP) and a second base station BWP that is smaller than the first base station BWP,
receive, through the transceiver, from the base station, control information indicating a BWP change to the first base station BWP or the second base station BWP, and
communicate with the base station, through the transceiver, in an overlapping area of the second base station BWP and a UE BWP configured for the UE, in case that the control information indicates the BWP change to the second base station BWP.

25. The UE of claim 24, wherein a size of the base station BWPs is smaller than or equal to a system bandwidth of the base station, and
wherein the processor is further configured to receive, through the transceiver, from the base station, at least one of a synchronization signal (SSB)/physical broadcast channel (PBCH) block or a reference signal in the overlapping area.

26. The UE of claim 24, wherein a mapping reference point of a reference signal received by the UE, from the base station, is configured based on one start point among the UE BWP, the first base station BWP, or the second base station BWP in a frequency domain.

27. A method performed by a user equipment (UE) in a wireless communication system, the method comprising:
receiving, from a base station, configuration information about base station bandwidth parts (BWPs) including a first base station (BWP) and a second base station BWP that is smaller than the first base station BWP;
receiving, from the base station, control information indicating a BWP change to the first base station BWP or the second base station BWP; and
communicating with the base station, through the transceiver, in an overlapping area of the second base station BWP and a UE BWP configured for the UE, in case that the control information indicates the BWP change to the second base station BWP.

28. The method of claim 27, wherein a size of the base station BWPs is smaller than or equal to a system bandwidth of the base station, and
wherein the UE receives, from the base station, at least one of a synchronization signal (SSB)/physical broadcast channel (PBCH) block or a reference signal in the overlapping area.

29. The method of claim 27, wherein a mapping reference point of a reference signal received by the UE, from the base station, is configured based on one start point among the UE BWP, the first base station BWP, or the second base station BWP in a frequency domain.
